(19) United States
(12) Patent Application Publication
(10) Pub. No.: US 2024/0397296 A1
(43) Pub. Date: Nov. 28, 2024

(54) Method for Providing a Network of Streaming Web Apps

(71) Applicant: Charles Albert Morris, Maquoketa, IA (US)

(72) Inventor: Charles Albert Morris, Maquoketa, IA (US)

(21) Appl. No.: 18/202,831

(22) Filed: May 26, 2023

(51) Int. Cl. H04W 4/60; G06F 3/0482; G06F 16/9537; G06Q 20/08; G06Q 20/38; H04L 9/40; H04L 67/568

(52) U.S. Cl. CPC H04W 4/60; G06F 3/0482; G06F 16/9537; G06Q 20/0855; G06Q 20/389; H04L 63/102; H04L 67/568

(57) ABSTRACT

A master app or master progressive web app (PWA) allows a network of registered PWAs, websites, and web pages to become streaming web apps that each open fullscreen without separate installation. The network provides each of the websites and web pages an icon, a web app manifest, a service worker, and an index page that references the sites/pages, so each can be separately cached, installed as a PWA, and opened from an icon on a home screen. While any one of the streaming web apps is open fullscreen, means, such as tapping a small logo for the network, are provided to users of the network to access a directory of other registered PWAs/sites/pages, each of which opens fullscreen for an app-like experience, without requiring that each site/page be cached or installed as a PWA.

### BACKGROUND OF THE INVENTION

The present invention relates to a network of registered websites and web pages that each open fullscreen within the network's native app (such as an iOS app or an Android app) or progressive web app (PWA,) wherein each of the registered websites and web pages can be cached and added to the home screen of a user's mobile computerized device.

Numerous embodiments of networks of registered apps exist in the prior art such as Apple's App Store and Google Play. However, each of these app directories require app creators to program the apps as native apps designed to work with a particular operating system. Once these native apps have been created, users must take the time to download and install each individual app in order to use them. Both Apple's App Store and Google Play allow users to open minimally functional portions of native apps without installing them, but each of these minimally functional portions of native apps must first be programmed as a native app or be a part of a native app.

PWAs are easier to create than native apps, and networks of registered PWAs exist in the prior art. US patent application US20190065217A1 discloses such a network; however, with such networks, users must install each PWA in order to have the PWA open full screen to provide an optimal app-like experience. My own patent, U.S. Pat. No. 9,986,408, which was written before Google introduced PWAs, discloses a network of apps that allow any one of the apps to open all of the apps in the network without separately downloading and installing each one, but it does not address the specific use of innovations introduced by PWAs.

It would be advantageous to provide a network of PWAs that allows the user to download and install just one of the PWAs onto the user's mobile computerized device in order to open that PWA fullscreen and be able to access a directory of other PWAs, mobile-ready websites, and mobile-ready web pages that are registered with the network, choose any one of these, and have it also open fullscreen without separately downloading, installing, and adding an icon to the home screen of the mobile computerized device. Each registered PWA/site/page opens fullscreen within the PWA that has been installed, which provides means to reopen the directory, such as an icon that overlaps whichever PWA/site/page is currently open fullscreen. By tapping the icon, the user is shown the directory and can choose other PWAs/sites/pages to open. In this way, countless PWAs, mobile-ready websites, and mobile-ready web pages can be instantly opened fullscreen for an optimal app-like experience without forcing the user to add countless icons to their home screens and without forcing the user to overload their mobile computerized devices with the cached files for each and every PWA/site/page they wish to open. Should the user choose to install a particular PWA/site/page as a PWA and add an icon to the home screen, the network provides means to do so.

It would also be advantageous to provide a native app that provides a directory of PWAs, mobile-ready websites, and mobile-ready web pages that are registered with the app, allow a user to choose any one of these, and have it open fullscreen without separately downloading, installing, and adding an icon to the home screen of the mobile computerized device. Each PWA/site/page opens fullscreen within the app, which provides means to reopen the directory, such as an icon that overlaps whichever PWA/site/page is currently open fullscreen. By tapping the icon, the user is shown the directory and can choose other PWAs/sites/pages to open. Should the user choose to install a particular PWA/site/page as a PWA and add an icon to the home screen, the app provides means to do so. The user can also choose to cache any number of PWAs/sites/pages without adding an icon to the home screen. Permissions that are granted by the user to the native app to access and utilize the mobile computerized device's camera, audio, location, contacts, files, documents, accelerometer, light sensor, and/or proximity sensor can also be automatically granted to any of the PWAs/sites/pages.

It would also be advantageous to provide a master PWA that allows the user to access a directory of other PWAs, mobile-ready websites, and mobile-ready web pages that are registered with a network of PWAs, choose any one of these, and have it open fullscreen without separately downloading, installing, and adding an icon to the home screen of the mobile computerized device. Each PWA/site/page opens fullscreen within the master PWA, which provides means to reopen the directory, such as an icon that overlaps whichever PWA/site/page is currently open fullscreen. By tapping the icon, the user is shown the directory and can choose other PWAs/sites/pages to open. The user can choose to cache any number of PWAs/sites/pages, and the web app manifest for the master PWA is rewritten to include within its scope of pages designated for caching all of the PWAs/sites/pages that have been chosen for caching. The user can also choose to delete any of these PWAs/sites/pages from the cache at any time. The user can choose to add an icon to the home screen for any of the cached PWAs/sites/pages. Permissions that are granted by the user to the master PWA to access and utilize the mobile computerized device's camera, audio, location, contacts, files, documents, accelerometer, light sensor, and/or proximity sensor can also be automatically granted to any of the PWAs/sites/pages.

It would also be advantageous to provide a user the ability to create a personal network of PWAs that allows the user to select any number of PWAs/sites/pages that are listed by a search engine and select any number of PWAs/sites/pages by typing in URLs for each. The user can choose to have files generated that will allow any number of these PWAs/sites/pages to function as PWAs. The user can then download any number of these files onto their mobile computerized device and cache any number of these PWAs/sites/pages. An app or a master PWA for the network of PWAs can open and display each of the selected PWAs/sites/pages fullscreen, even if the user has not downloaded the files that are needed to allow a particular PWA/site/page to function as a PWA and/or has not chosen to cache a particular PWA/site/page.

It would also be advantageous to provide a user or group of users the ability to create a private network of PWAs that allows the user or group of users to create any number of PWAs/sites/pages and have files generated that will allow any number of these PWAs/sites/pages to function as a PWA. The user or group of users can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. Access to PWAS/sites/pages can be limited to those who have been authorized and have signed into the app or master PWA, which passes along the authorization to each of the PWAS/sites/pages.

It would also be advantageous to provide a network of PWAs in which organizations in a particular region or city are invited to create a sub-network and invite local businesses, organizations, and individuals within their communities to list their own PWAs, mobile-ready websites, and mobile-ready web pages on the sub-network and have files generated that will allow any number of these PWAs/sites/pages to function as a PWA. Users of the sub-network can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. The rating for each of the PWAs/sites/pages can be determined in the following way: each member of the network of PWAs makes a donation to the network of PWAs and a percentage of this donation is divvied up and distributed as tips to the owners of each PWA/site/page that has been starred/liked by the member. Direct donations in amounts chosen by users can also positively effect ratings.

It would also be advantageous to allow users of a network of PWAs to be able to access time-relevant lists of PWAs, mobile-ready websites, and mobile-ready web pages that have been registered with the network of PWAs, being presented with PWAs/sites/pages that have been tagged as relevant to a specific period of time, including the present or a specific period of time selected by the user. The specific period of time tagged as relevant to each PWA/site/page can have a set activation and expiration date and can also be set to recur at one of the following intervals: annually, monthly, weekly, at a specific time daily, at multiple specific times daily, and at random intervals.

It would also be advantageous to allow users of a network of PWAs to be able to access PWAs, mobile-ready websites, and mobile-ready web pages that have been registered with the network of PWAs only if the users are part of the following populations: the general public, only members of an organization, only individuals who register with at least one of the PWAs/sites/pages, only a specific group of people, only employees of a company, only people who have been given specific rights to access at least one of the PWAs/sites/pages, only those who pass a biometric test that determines authorization to access at least one of the PWAs/sites/pages, only those who are in a specified location, only those who scan a specific bar code, only those who scan a specific QR code, only those whose mobile device communicates with a close-proximity wireless device associated with at least one of the PWAs/sites/pages, only those whose mobile device communicates with a close-proximity wireless device embedded in an object associated with at least one of the PWAs/sites/pages, only people who are members of the network of PWAS, only people who have earned a reputation as trusted members of the network of PWAs, and only people who have purchased the right to access at least one of the PWAs/sites/pages. Each PWA/site/page opens fullscreen within a master PWA that has been installed, which provides means to reopen the directory, such as an icon that overlaps whichever PWA/site/page is currently open fullscreen. By tapping the icon, the user is shown the directory and can choose to open other PWAs/sites/pages that have been registered with the network of PWAs.

It would also be advantageous to allow users of a network of PWAs to be able to access lists of PWAs, mobile-ready websites, and mobile-ready web pages that have been registered with the network of PWAs and are each dedicated to at least one of the following: a specific commercial item, a specific commercial product, a smart object, a specific location, a specific place of business, a specific neighborhood, a specific place of interest, and a person. These PWAs/sites/pages are promoted to users under at least one of the following conditions: when a user enters a specific geographic area, when a user enters a specific place of business, when a user enters a specific neighborhood, when a user enters a specific place of interest, when a user is in close proximity to a person, when a user is in close proximity to a mobile business, when a user enters a product code, when a user's mobile computerized device is connected by way of a data transfer cord to a computerized device associated with a specific commercial item, when a user's mobile computerize devices scans a bar code, when a user's mobile computerized device scans a QR code, when a user's mobile computerized device communicates with a close-proximity wireless device, when a user's mobile computerized device communicates with a close-proximity wireless device embedded within a specific commercial item, and when a user's mobile computerized device communicates with a close-proximity wireless device attached to a specific commercial item. When a user accesses one of these PWAs/sites/pages dedicated to one of the following: a specific commercial item, a specific commercial product, a smart object, a specific place of business, a specific neighborhood, a specific place of interest, and a person, the user can use the PWA/site/page to interact with that to which the PWA/site/page is dedicated. Each PWA/site/page opens fullscreen within a master PWA that has been installed, which provides means to reopen the directory, such as an icon that overlaps whichever PWA/site/page is currently open fullscreen. By tapping the icon, the user is shown the directory and can choose other PWAs/sites/pages to open.

It would also be advantageous to provide means to navigate a broad array of PWAs/sites/pages that have been registered with a network of PWAs by allowing the user to select at least one channel on at least one of the following dials or sub-dials: a circular dial of primary channels that has the following progression of channels: a business channel, a service channel, an event channel, an activity channel, a place of interest channel, a cultural venue channel, and back to the business channel; a circular sub-dial of the business channel that has the following progression of channels: a store/retail channel, a restaurant/cafe channel, a bar/club/casino channel, a lodging channel, an entertainment channel, a sports venue channel, a media company channel, a communications provider channel, an infrastructure builder channel, an energy/fuel company channel, an agricultural company channel, a raw materials company channel, a maker/manufacturer channel, a wholesale company channel, a real estate agency channel, a banking/finance channel, an insurance company channel, a security company channel, a lawyer/law firm channel, a nonprofit channel, an educational organization channel, and back to the store/retail channel; a circular sub-dial of the service channel that has the following progression of channels: a transportation channel, a shopping/delivery channel, a shipping/packing channel, a storage/warehouse channel, an installation/assembly channel, a construction/builder channel, a decorator/framer channel, a creation/recording channel, a cooking/catering channel, a teaching/demo channel, a beauty/fitness channel, a personal care channel, a health care channel, a government services channel, a farm services channel, a pet care channel, a lawn/garden care channel, a cleaning/removal channel, a repair/maintenance channel, an auto service channel, and back to the transportation channel; a circular sub-dial of the event channel that has the following progression of channels: a show/performance channel, a sports event channel, a social gathering channel, a creative event channel, a class channel, a conference/presentation channel, a business meeting channel, a civic/political event channel, and back to the show/performance channel; a circular sub-dial of the activity channel that has the following progression of channels: a hiking channel, a camping channel, a hunting/fishing channel, a climbing channel, a horse riding channel, a cycling channel, a running channel, a sports channel, an e-sports channel, an arcade channel, a board games channel, a card games channel, a gambling channel, and back to the hiking channel; a circular sub-dial of the place of interest channel that has the following progression of channels: an historical site channel, an historical building channel, a memorial channel, a cemetery channel, a religious gathering place channel, a site held sacred channel, a public nature channel, a bike path channel, a walking path channel, a sculpture park/AR site channel, a city park channel, a state park channel, a national park channel, and back to the historical site channel; and a circular sub-dial of the cultural venue channel that has the following progression of channels: an arts venue channel, a library channel, a special collections channel, a historical museum channel, a natural history museum channel, a science museum channel, an aquarium channel, a zoo/wildlife park channel, a children's museum channel, an amusement park channel, an arcade channel, a carnival/fair channel, a sports venue channel, and back to the arts venue channel.

It would also be advantageous to provide means to navigate a broad array of PWAs/sites/pages that have been registered with a network of PWAs by allowing the user to select at least one channel on at least one of the following dials or sub-dials: a circular dial for the selection of media types that has the following progression of channels: a photo channel, a video channel, an audio/voice channel, a writing channel, a music channel, a multimedia channel, an app/PWA channel, an interactive media channel, a video game channel, a 3D/VR/AR channel, a graphic design channel, a 2D art channel, and back to the photo channel; a circular dial for the selection of subject matter that has the following progression of channels: a nature channel, a person/personal channel, a people/group channel, a political issue channel, an activity channel, an event channel, a business channel, a service channel, an arts channel, a product/thing channel, a real estate channel, an infrastructure channel, a data channel, an abstraction channel, a time/date channel, a place channel, and back to the nature channel; a circular dial for the selection of genre/point of view that has the following progression of channels: a report/real life channel, a dramatization channel, a drama/fiction channel, an action/adventure channel, a comedy/satire channel, an emotional reaction channel, a lies/propaganda channel, a beliefs channel, a fantasy/sci-fi channel, a theory/prediction channel, an opinion/review channel, a how-to/recipe channel, an abstraction/design channel, a science/stats channel, and back to the report/real life channel; a circular dial for the selection of the aesthetic expressed in a piece of media that has the following progression of channels: a refined/elegant channel, a beautiful/idyllic channel, an ornate/elaborate channel, a chaotic/frenetic channel, an ugly/disturbing channel, an absurd/comical channel, a crude/clumsy channel, a naive childlike channel, a cute/sentimental channel, a simple/clean channel, and back to the refined/elegant channel; a circular dial for the selection of the emotional tone expressed in a piece of media that has the following progression of channels: a confident/bold channel, a superior/self-righteous channel, a cool/distant channel, a serious/solemn channel, a sad/mournful channel, a hopeless/depressed channel, a shy/uncertain channel, a fearful/nervous channel, a surprised/shocked channel, a disgusted/irritated channel, an angry/hostile channel, a jealous/envious channel, a passionate/obsessed channel, a manic/erratic channel, an excited/enthusiastic channel, a comic/sarcastic channel, a playful/silly channel, a hopeful/positive channel, a happy/joyous channel, a loving/connected channel, a calm/contented channel, and back to the confident/bold channel; a circular dial for the selection of the bias/interests expressed in a piece of media that has the following progression of channels: a political ideology channel, a political party interests channel, a class interests channel, a worker/professional interests channel, a business interests channel, an ethnic/national interests channel, a local/regional interests channel, a family interests channel, a self-interest channel, a gender interests channel, a sexual-orientation group interests channel, a generational interests channel, an environmental interests channel, a for the good of all humanity channel, a worldview/beliefs channel, and back to the political ideology channel; a circular dial for the selection of channels that describe the creator of a piece of media that has the following progression of channels: a by an individual channel, a by a group/collaboration channel, a by artificial intelligence channel, a by a company/organization channel, a by a government channel, a by a wiki/public forum channel, a created by me/us channel, and back to the by an individual channel; a circular dial for the selection of channels that describe the date that a piece of media was created that has the following progression of channels: a live/now channel, a today channel, a specific date channel, a range of dates channel, an oldest channel, a most recent channel, and back to the live/now channel; a circular dial for the selection of channels that describe the place that a piece of media was created that has the following progression of channels: a here channel, a nearby channel, a type of place channel, a specific neighborhood channel, a city channel, a region channel, a state/province channel, a country channel, a my/our favorite places channel, a my/our home channel, and back to the here channel; a circular dial for the selection of channels that describe the intended audience for a piece of media that has the following progression of channels: a private/paid channel, an invitation only channel, an audience in place/region channel, a general public channel, an adults only channel, a specific profession channel, an academics channel, a college and higher channel, a high school channel, a middle school channel, an elementary school channel, a preschool channel, and back to the private/paid channel; and a circular dial for the selection of a method for sorting media files that has the following progression of channels: a most-tipped recently channel, a most-tipped all time channel, an award winners channel, a my favorites channel, a recommended by editors channel, a random channel, a most recent channel, a new works by favorite creators channel, and back to the most-tipped recently channel.

### BRIEF SUMMARY OF THE INVENTION

It is an object of the invention to provide a master PWA that allows the user to access a directory of other PWAs, mobile-ready websites, and mobile-ready web pages that are registered with a network of PWAs, choose any one of these, and have it open fullscreen without separately downloading, installing, and adding an icon to the home screen of the mobile computerized device. Each PWA/site/page opens fullscreen within the master PWA, which provides means to reopen the directory, such as an icon that overlaps whichever PWA/site/page is currently open fullscreen. By tapping the icon, the user is shown the directory and can choose other PWAs/sites/pages to open. The user can choose to cache any number of PWAs/sites/pages, and the web app manifest for the master PWA is rewritten to include within its scope of pages designated for caching all of the PWAs/sites/pages that have been chosen for caching. The user can also choose to delete any of these PWAs/sites/pages from the cache at any time. The user can choose to add an icon to the home screen for any of the cached PWAs/sites/pages. Permissions that are granted by the user to the master PWA to access and utilize the mobile computerized device's camera, audio, location, contacts, files, documents, accelerometer, light sensor, and/or proximity sensor can also be automatically granted to any of the PWAs/sites/pages.

It is a further object of the invention to provide a native app that provides a directory of PWAs, mobile-ready websites, and mobile-ready web pages that are registered with the app, allow a user to choose any one of these, and have it open fullscreen without separately downloading, installing, and adding an icon to the home screen of the mobile computerized device. Each PWA/site/page opens fullscreen within the app, which provides means to reopen the directory, such as an icon that overlaps whichever PWA/site/page is currently open fullscreen. By tapping the icon, the user is shown the directory and can choose other PWAs/sites/pages to open. Should the user choose to install a particular PWA/site/page as a PWA and add an icon to the home screen, the app provides means to do so. The user can also choose to cache any number of PWAs/sites/pages without adding an icon to the home screen. Permissions that are granted by the user to the native app to access and utilize the mobile computerized device's camera, audio, location, contacts, files, documents, accelerometer, light sensor, and/or proximity sensor can also be automatically granted to any of the PWAs/sites/pages.

It is a further object of the invention to provide a network of PWAs that allows the user to download and install just one of the PWAs onto the user's mobile computerized device in order to open that PWA fullscreen and be able to access a directory of other PWAs, mobile-ready websites, and mobile-ready web pages that are registered with the network, choose any one of these, and have it also open fullscreen without separately downloading, installing, and adding an icon to the home screen of the mobile computerized device. Each PWA/site/page opens fullscreen within the PWA that has been installed, which provides means to reopen the directory, such as an icon that overlaps whichever PWA/site/page is currently open fullscreen. By tapping the icon, the user is shown the directory and can choose other PWAs/sites/pages to open. In this way, countless PWAs, mobile-ready websites, and mobile-ready web pages can be instantly opened fullscreen for an optimal app-like experience without forcing the user to add countless icons to their home screens and without forcing the user to overload their mobile computerized devices with the cached files for each and every PWA/site/page they wish to open. Should the user choose to install a particular PWA/site/page as a PWA and add an icon to the home screen, the network provides means to do so.

It is a further object of the invention to provide a network of PWAs that allows a user to download a master PWA that provides access to a directory of other PWAS, mobile-ready websites, and mobile-ready web pages that are registered with the network. The user can then choose any one of these PWAs/sites/pages, and have a selected PWA/site/page open fullscreen without separately downloading, installing, and adding an icon to the home screen of the mobile computerized device. The selected PWA/site/page opens fullscreen as a frame within the PWA that has been installed. The master PWA provides means to reopen the directory, such as an icon that overlaps the PWA/site/page that is currently open fullscreen. By tapping the icon, the user is shown the directory and can choose other PWAs/sites/pages to open fullscreen without separately downloading, installing, and adding an icon to the home screen of the mobile computerized device. The user can choose to add to the cache any number of particular PWAs/sites/pages, and the web app manifest for the master PWA is rewritten to include within its scope of pages designated for caching all of the particular PWAs/sites/pages that have been chosen for caching. The user can also choose to delete any of the particular PWAs/sites/pages from the cache at any time.

It is a further object of the invention to provide a user the ability to create a personal network of PWAs that allows the user to select any number of PWAs/sites/pages that are listed by a search engine and select any number of PWAs/sites/pages by typing in URLs for each. The user can choose to have files generated that will allow any number of these PWAs/sites/pages to function as PWAs. The user can then download any number of these files onto their mobile computerized device and cache any number of these PWAs/sites/pages. An app or a master PWA for the network of PWAs can open and display each of the selected PWAs/sites/pages fullscreen, even if the user has not downloaded the files that are needed to allow a particular PWA/site/page to function as a PWA and/or has not chosen to cache a particular PWA/site/page.

It is a further object of the invention to provide a user or group of users the ability to create a private network of PWAs that allows the user or group of users to create any number of PWAs/sites/pages and have files generated that will allow any number of these PWAs/sites/pages to function as a PWA. The user or group of users can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. Access to PWASs/sites/pages can be limited to those who have been authorized and have signed into the app or master PWA, which passes along the authorization to each of the PWAs/sites/pages.

It is a further object of the invention to provide a network of PWAs in which organizations in a particular region or city are invited to create a sub-network and invite local businesses, organizations, and individuals within their communities to list their own PWAs, mobile-ready websites, and mobile-ready web pages on the sub-network and have files generated that will allow any number of these PWAs/sites/pages to function as a PWA. Users of the sub-network can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. The rating for each of the PWAs/sites/pages can be determined in the following way: each member of the network of PWAs makes a donation to the network of PWAs and a percentage of this donation is divvied up and distributed as tips to the owners of each PWA/site/page that has been starred/liked by the member. Direct donations in amounts chosen by users can also positively effect ratings.

It is a further object of the invention to provide users of a network of PWAs access to lists of PWAs, mobile-ready websites, and mobile-ready web pages that have been tagged as relevant to a specific period of time, including the present or a specific period of time selected by the user. The specific period of time tagged as relevant to each PWA/site/page can have a set activation and expiration date and can also be set to recur at one of the following intervals: annually, monthly, weekly, at a specific time daily, at multiple specific times daily, and at random intervals.

It is a further object of the invention to provide users of a network of PWAs access to lists of PWAs, mobile-ready websites, and mobile-ready web pages that have been registered with the network of PWAs only if the users are part of the following populations: the general public, only members of an organization, only individuals who register with at least one of the PWAs/sites/pages, only a specific group of people, only employees of a company, only people who have been given specific rights to access at least one of the PWAs/sites/pages, only those who pass a biometric test that determines authorization to access at least one of the PWAs/sites/pages, only those who are in a specified location, only those who scan a specific bar code, only those who scan a specific QR code, only those whose mobile device communicates with a close-proximity wireless device associated with at least one of the PWAs/sites/pages, only those whose mobile device communicates with a close-proximity wireless device embedded in an object associated with at least one of the PWAs/sites/pages, only people who are members of the network of PWAs, only people who have earned a reputation as trusted members of the network of PWAs, and only people who have purchased the right to access at least one of the PWAs/sites/pages.

It is a further object of the invention to provide users of a network of PWAs access to lists of PWAs, mobile-ready websites, and mobile-ready web pages that have been registered with the network of PWAs and are each dedicated to at least one of the following: a specific commercial item, a specific commercial product, a smart object, a specific location, a specific place of business, a specific neighborhood, a specific place of interest, and a person. These PWAs/sites/pages are promoted to users under at least one of the following conditions: when a user enters a specific geographic area, when a user enters a specific place of business, when a user enters a specific neighborhood, when a user enters a specific place of interest, when a user is in close proximity to a person, when a user is in close proximity to a mobile business, when a user enters a product code, when a user's mobile computerized device is connected by way of a data transfer cord to a computerized device associated with a specific commercial item, when a user's mobile computerize devices scans a bar code, when a user's mobile computerized device scans a QR code, when a user's mobile computerized device communicates with a close-proximity wireless device, when a user's mobile computerized device communicates with a close-proximity wireless device embedded within a specific commercial item, and when a user's mobile computerized device communicates with a close-proximity wireless device attached to a specific commercial item. When a user accesses one of these PWAs/sites/pages dedicated to one of the following: a specific commercial item, a specific commercial product, a smart object, a specific place of business, a specific neighborhood, a specific place of interest, and a person, the user can use the PWA/site/page to interact with that to which the PWA/site/page is dedicated.

It is a further object of the invention to provide means to navigate a broad array of PWAs/sites/pages that have been registered with a network of PWAs by allowing the user to select at least one channel on at least one of the following dials or sub-dials: a circular primary dial that has the following progression of channels: a business channel, a service channel, an event channel, an activity channel, a place of interest channel, a cultural venue channel, and back to the business channel; a circular sub-dial of the business channel that has the following progression of channels: a store/retail channel, a restaurant/cafe channel, a bar/club/casino channel, a lodging channel, an entertainment channel, a sports venue channel, a media company channel, a communications provider channel, an infrastructure builder channel, an energy/fuel company channel, an agricultural company channel, a raw materials company channel, a maker/manufacturer channel, a wholesale company channel, a real estate agency channel, a banking/finance channel, an insurance company channel, a security company channel, a lawyer/law firm channel, a nonprofit channel, an educational organization channel, and back to the store/retail channel; a circular sub-dial of the service channel that has the following progression of channels: a transportation channel, a shopping/delivery channel, a shipping/packing channel, a storage/warehouse channel, an installation/assembly channel, a construction/builder channel, a decorator/framer channel, a creation/recording channel, a cooking/catering channel, a teaching/demo channel, a beauty/fitness channel, a personal care channel, a health care channel, a government services channel, a farm services channel, a pet care channel, a lawn/garden care channel, a cleaning/removal channel, a repair/maintenance channel, an auto service channel, and back to the transportation channel; a circular sub-dial of the event channel that has the following progression of channels: a show/performance channel, a sports event channel, a social gathering channel, a creative event channel, a class channel, a conference/presentation channel, a business meeting channel, a civic/political event channel, and back to the show/performance channel; a circular sub-dial of the activity channel that has the following progression of channels: a hiking channel, a camping channel, a hunting/fishing channel, a climbing channel, a horse riding channel, a cycling channel, a running channel, a sports channel, an e-sports channel, an arcade channel, a board games channel, a card games channel, a gambling channel, and back to the hiking channel; a circular sub-dial of the place of interest channel that has the following progression of channels: an historical site channel, an historical building channel, a memorial channel, a cemetery channel, a religious gathering place channel, a site held sacred channel, a public nature channel, a bike path channel, a walking path channel, a sculpture park/AR site channel, a city park channel, a state park channel, a national park channel, and back to the historical site channel; and a circular sub-dial of the cultural venue channel that has the following progression of channels: an arts venue channel, a library channel, a special collections channel, a historical museum channel, a natural history museum channel, a science museum channel, an aquarium channel, a zoo/wildlife park channel, a children's museum channel, an amusement park channel, an arcade channel, a carnival/fair channel, a sports venue channel, and back to the arts venue channel.

It is a further object of the invention to provide means to navigate a broad array of PWAs/sites/pages that allows a user filter a broad array of listed PWAs/sites/pages by allowing the user to select at least one channel on at least one of the following: a circular dial for the selection of subject matter that has the following progression of channels: a nature channel, a person/personal channel, a people/group channel, a political issue channel, an activity channel, an event channel, a business channel, a service channel, an arts channel, a product/thing channel, a real estate channel, an infrastructure channel, a data channel, an abstraction channel, a time/date channel, a place channel, and back to the nature channel; a circular dial for the selection of the bias/interests expressed that has the following progression of channels: a political ideology channel, a political party interests channel, a class interests channel, a worker/professional interests channel, a business interests channel, an ethnic/national interests channel, a local/regional interests channel, a family interests channel, a self-interest channel, a gender interests channel, a sexual-orientation group interests channel, a generational interests channel, an environmental interests channel, a for the good of all humanity channel, a worldview/beliefs channel, and back to the political ideology channel; a circular dial for the selection of the emotional tone expressed that has the following progression of channels: a confident/bold channel, a superior/self-righteous channel, a cool/distant channel, a serious/solemn channel, a sad/mournful channel, a hopeless/depressed channel, a shy/uncertain channel, a fearful/nervous channel, a surprised/shocked channel, a disgusted/irritated channel, an angry/hostile channel, a jealous/envious channel, a passionate/obsessed channel, a manic/erratic channel, an excited/enthusiastic channel, a comic/sarcastic channel, a playful/silly channel, a hopeful/positive channel, a happy/joyous channel, a loving/connected channel, a calm/contented channel, and back to the confident/bold channel; a circular dial for the selection of genre/point of view that has the following progression of channels: a report/real life channel, a dramatization channel, a drama/fiction channel, an action/adventure channel, a comedy/satire channel, an emotional reaction channel, a lies/propaganda channel, a beliefs channel, a fantasy/sci-fi channel, a theory/prediction channel, an opinion/review channel, a how-to/recipe channel, an abstraction/design channel, a science/stats channel, and back to the report/real life channel; a circular dial for the selection of media types that has the following progression of channels: a photo channel, a video channel, an audio/voice channel, a writing channel, a music channel, a multimedia channel, an app/PWA channel, an interactive media channel, a video game channel, a 3D/VR/AR channel, a graphic design channel, a 2D art channel, and back to the photo channel; a circular dial for the selection of channels that describe the intended audience that has the following progression of channels: a private/paid channel, an invitation only channel, an audience in place/region channel, a general public channel, an adults only channel, a specific profession channel, an academics channel, a college and higher channel, a high school channel, a middle school channel, an elementary school channel, a preschool channel, and back to the private/paid channel; a circular dial for the selection of a method for sorting that has the following progression of channels: a most-tipped recently channel, a most-tipped all time channel, an award winners channel, a my favorites channel, a recommended by editors channel, a random channel, a most recent channel, a new works by favorite creators channel, and back to the most-tipped recently channel; a circular dial for the selection of channels that describe the creator/author that has the following progression of channels: a by an individual channel, a by a group/collaboration channel, a by artificial intelligence channel, a by a company/organization channel, a by a government channel, a by a wiki/public forum channel, a created by me/us channel, and back to the by an individual channel; a circular dial for the selection of the aesthetic expressed that has the following progression of channels: a refined/elegant channel, a beautiful/idyllic channel, an ornate/elaborate channel, a chaotic/frenetic channel, an ugly/disturbing channel, an absurd/comical channel, a crude/clumsy channel, a naive/childlike channel, a cute/sentimental channel, a simple/clean channel, and back to the refined/elegant channel; a circular dial for the selection of channels that describe the date created that has the following progression of channels: a live/now channel, a today channel, a specific date channel, a range of dates channel, an oldest channel, a most recent channel, and back to the live/now channel; and a circular dial for the selection of channels that describe the place created that has the following progression of channels: a here channel, a nearby channel, a type of place channel, a specific neighborhood channel, a city channel, a region channel, a state/province channel, a country channel, a my/our favorite places channel, a my/our home channel, and back to the here channel.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 shows a block diagram of an exemplary network of progressive web apps (PWAs) in accordance with some embodiments of the invention in which a master PWA allows users to access a directory of other PWAs, mobile-ready websites, and mobile-ready web pages that are registered with a network of PWAs, choose any one of these, and have it open fullscreen without separately downloading, installing, and adding an icon to the home screen of the mobile computerized device; and

FIG. 2 shows a block diagram of an exemplary network of progressive web apps (PWAs) in accordance with some embodiments of the invention in which a native app provides a directory of PWAs, mobile-ready websites, and mobile-ready web pages that are registered with the app, allow a user to choose any one of these, and have it open fullscreen without separately downloading, installing, and adding an icon to the home screen of the mobile computerized device; and

FIG. 3 shows a block diagram of an exemplary network of progressive web apps (PWAs) in accordance with some embodiments of the invention in which a user can download and install just one of the PWAs listed on the network onto the user's mobile computerized device in order to open that PWA fullscreen and be able to access a directory of other PWAs, mobile-ready websites, and mobile-ready web pages that are registered with the network, choose any one of these, and have it also open fullscreen without separately downloading, installing, and adding an icon to the home screen of the mobile computerized device; and

FIG. 4 shows a block diagram of an exemplary network of progressive web apps (PWAs) in accordance with some embodiments of the invention in which a master PWA provides access to a directory of other PWAs, mobile-ready websites, and mobile-ready web pages that are registered with the network. The user can then choose any one of these PWAs/sites/pages, and have a selected PWA/site/page open fullscreen without separately downloading, installing, and adding an icon to the home screen of the mobile computerized device. The master PWA provides means to reopen the directory, such as an icon that overlaps the PWA/site/page that is currently open fullscreen. By tapping the icon, the user is shown the directory and can choose other PWAs/sites/pages to open fullscreen without separately downloading, installing, and adding an icon to the home screen of the mobile computerized device. The user can choose to add to the cache any number of particular PWAs/sites/pages, and the web app manifest for the master PWA is rewritten to include within its scope of pages designated for caching all of the particular PWAs/sites/pages that have been chosen for caching. The user can also choose to delete any of the particular PWAs/sites/pages from the cache at any time; and

FIG. 5 shows a block diagram of an exemplary network of progressive web apps (PWAs) in accordance with some embodiments of the invention in which a user can create a personal network of PWAs that allows the user to select any number of PWAs/sites/pages that are listed by a search engine and select any number of PWAs/sites/pages by typing in URLs for each. The user can choose to have files generated that will allow any number of these PWAs/sites/pages to function as PWAs. The user can then download any number of these files onto their mobile computerized device and cache any number of these PWAs/sites/pages. A native app for the network of PWAs can open and display each of the selected PWAs/sites/pages fullscreen, even if the user has not downloaded the files that are needed to allow a particular PWA/site/page to function as a PWA and/or has not chosen to cache a particular PWA/site/page; and

FIG. 6 shows a block diagram of an exemplary network of progressive web apps (PWAs) in accordance with some embodiments of the invention in which a user or group of users can create a private network of PWAs that allows the user or group of users to create any number of PWAs/sites/pages and have files generated that will allow any number of these PWAs/sites/pages to function as a PWA. The user or group of users can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. Access to PWAs/sites/pages can be limited to those who have been authorized and have signed into the app or master PWA, which passes along the authorization to access each of the PWAs/sites/pages; and

FIG. 7 shows a block diagram of an exemplary network of progressive web apps (PWAs) in accordance with some embodiments of the invention in which organizations in a particular region or city are invited to create a sub-network and invite local businesses, organizations, and individuals within their communities to list their own PWAs, mobile-ready websites, and mobile-ready web pages on the sub-network and have files generated that will allow any number of these PWAs/sites/pages to function as a PWA. Users of the sub-network can then use an app or a master PWA to download any number of these files onto their mobile computerized devices and cache any number of these PWAs/sites/pages. The app or master PWA for the network of PWAs can open and display each of the selected PWAs/sites/pages fullscreen, even if the user or group of users has not downloaded the files that are needed to allow a particular PWA/site/page to function as a PWA and/or has not chosen to cache a particular PWA/site/page. The rating for each of the PWAs/sites/pages can be determined in the following way: each member of the network of PWAs makes a donation to the network of PWAs and a percentage of this donation is divvied up and distributed as tips to the owners of each PWA/site/page that has been starred/liked by the member. Direct donations in amounts chosen by users can also positively effect ratings; and

FIG. 8 shows a block diagram of an exemplary network of progressive web apps (PWAs) in accordance with some embodiments of the invention in which users of the network of PWAs can access lists of PWAs, mobile-ready websites, and mobile-ready web pages that have been tagged as relevant to a specific period of time, including the present or a specific period of time selected by the user. The specific period of time tagged as relevant to each PWA/site/page can have a set activation and expiration date and can also be set to recur at one of the following intervals: annually, monthly, weekly, at a specific time daily, at multiple specific times daily, and at random intervals; and

FIG. 9 shows a block diagram of an exemplary network of progressive web apps (PWAs) in accordance with some embodiments of the invention in which users of the network of PWAs can access lists of PWAs, mobile-ready websites, and mobile-ready web pages that have been registered with the network of PWAs only if the users are part of the following populations: the general public, only members of an organization, only individuals who register with at least one of the PWAs/sites/pages, only a specific group of people, only employees of a company, only people who have been given specific rights to access at least one of the PWAs/sites/pages, only those who pass a biometric test that determines authorization to access at least one of the PWAs/sites/pages, only those who are in a specified location, only those who scan a specific bar code, only those who scan a specific QR code, only those whose mobile device communicates with a close-proximity wireless device associated with at least one of the PWAs/sites/pages, only those whose mobile device communicates with a close-proximity wireless device embedded in an object associated with at least one of the PWAs/sites/pages, only people who are members of the network of PWAs, only people who have earned a reputation as trusted members of the network of PWAs, and only people who have purchased the right to access at least one of the PWAs/sites/pages; and

FIG. 10 shows a block diagram of an exemplary network of progressive web apps (PWAs) in accordance with some embodiments of the invention in which users of a network of PWAs access to lists of PWAs, mobile-ready websites, and mobile-ready web pages that have been registered with the network of PWAs and are each dedicated to at least one of the following: a specific commercial item, a specific commercial product, a smart object, a specific location, a specific place of business, a specific neighborhood, a specific place of interest, and a person. When a user accesses one of these PWAs/sites/pages dedicated to one of the following: a specific commercial item, a specific commercial product, a smart object, a specific place of business, a specific neighborhood, a specific place of interest, and a person, the user can use the PWA/site/page to interact with that to which the PWA/site/page is dedicated; and

FIG. 11 shows a block diagram of an exemplary network of progressive web apps (PWAs) in accordance with some embodiments of the invention in which users are provided with the means to navigate a broad array of PWAs/sites/pages by selecting at least one channel on a plurality of dials and sub-dials; and

FIG. 12 shows a block diagram of an exemplary network of progressive web apps (PWAs) in accordance with some embodiments of the invention in which users are provided with the means to navigate a broad array of PWAs/sites/pages by selecting at least one channel on several dials.

### DETAILED DESCRIPTION OF THE INVENTION

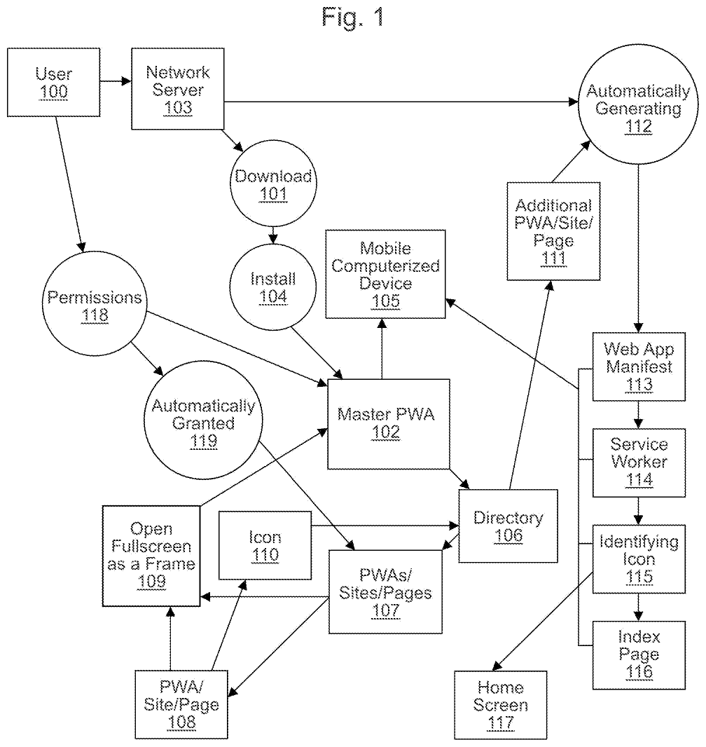

In FIG. 1, there is shown a block diagram of an exemplary embodiment of a network of PWAs that allows a user 100 to download 101 a master PWA 102 from a network server 103 and install 104 the master PWA 102 onto the user's mobile computerized device 105 in order to open the master PWA 102 fullscreen and be able to access a directory 106 of PWAs, mobile-ready websites, and mobile-ready web pages 107 that are registered with the network. The user 100 can then choose any one of these PWAs, mobile-ready websites, and mobile-ready web pages 107, and have a selected PWA/site/page 108 open fullscreen 109 without separately downloading, installing, and adding an icon to the home screen of the mobile computerized device. The selected PWA/site/page 108 opens fullscreen as a frame 109 within the master PWA 102. The master PWA 102 provides means to reopen the directory 106, such as an icon 110 that overlaps the PWA/site/page 108 that is currently open fullscreen. By tapping the icon 110, the user 100 is shown the directory 106 and can choose other PWAs/sites/pages 107 to open fullscreen 109 without separately downloading, installing, and adding an icon to the home screen of the mobile computerized device. In this way, countless PWAs, mobile-ready websites, and mobile-ready web pages can be instantly opened fullscreen for an optimal app-like experience without forcing the user 100 to add countless icons to their home screens and without forcing the user to overload their mobile computerized devices with the cached files for each and every PWA/site/page they wish to open. Should the user 100 choose to install an additional PWA/site/page 111 as a PWA and add an icon to the home screen, the network provides means to do so by automatically generating 112 a web app manifest 113, a service worker 114, an identifying icon 115, and an index page 116 that references the web app manifest 113 and the service worker 114. These files 113-116 are downloaded to the users' mobile computerized device 105, and the identifying icon 115 is placed on the home screen 117 of the user's mobile computerized device 105. Permissions 118 that are granted by the user 100 to the master PWA 102 to access and utilize the mobile computerized device's camera, audio, location, contacts, files, documents, accelerometer, light sensor, and/or proximity sensor can also be automatically granted 119 to any of the PWAs/sites/pages 107.

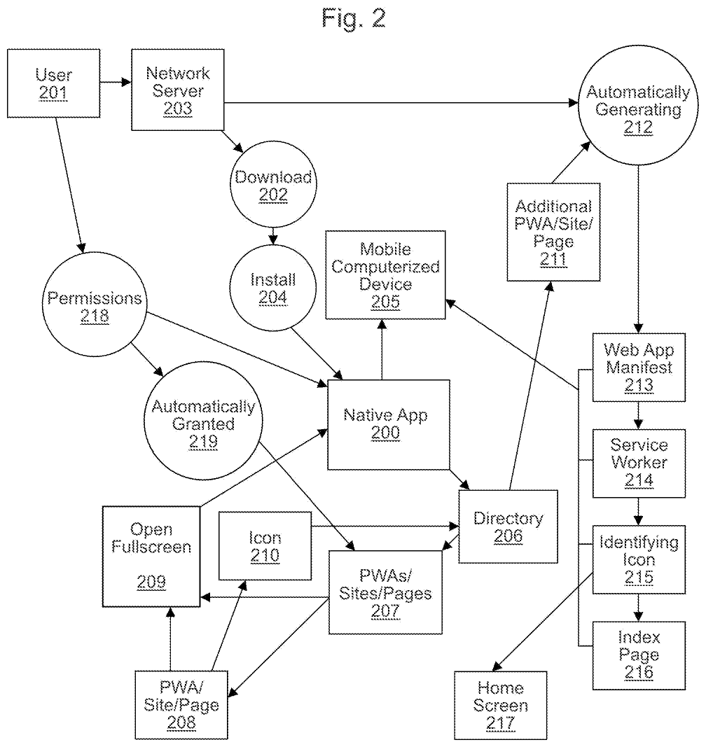

In FIG. 2, there is shown a block diagram of an exemplary embodiment of a network of PWAs that provides a native app 200 that a user 201 downloads 202 from a network server 203 and installs 204 onto the user's mobile computerized device 205 in order to open that native app 200 fullscreen and be able to access a directory 206 of other PWAs, mobile-ready websites, and mobile-ready web pages 207 that are registered with the network. The user 200 can then choose any one of these PWAs, mobile-ready websites, and mobile-ready web pages 207, and have a selected PWA/site/page 208 open fullscreen 209 without separately downloading, installing, and adding an icon to the home screen of the mobile computerized device. The selected PWA/site/page 208 opens fullscreen 209 within the native app 200. The native app 200 provides means to reopen the directory 206, such as an icon 210 that overlaps the PWA/site/page 208 that is currently open fullscreen. By tapping the icon 210, the user 200 is shown the directory 206 and can choose other PWAs/sites/pages 207 to open fullscreen 209 without separately downloading, installing, and adding an icon to the home screen of the mobile computerized device. In this way, countless PWAs, mobile-ready websites, and mobile-ready web pages can be instantly opened fullscreen for an optimal app-like experience without forcing the user 200 to add countless icons to their home screens and without forcing the user 200 to overload their mobile computerized device with the cached files for each and every PWA/site/page they wish to open. Should the user 200 choose to install an additional PWA/site/page 211 as a PWA and add an icon to the home screen, the network provides means to do so by automatically generating 212 a web app manifest 213, a service worker 214, an identifying icon 215, and an index page 216 that references the web app manifest 213 and the service worker 214. These files 213-216 are downloaded to the users' mobile computerized device 205, and the identifying icon 215 is placed on the home screen 217 of the user's mobile computerized device 205. Permissions 218 that are granted by the user to the native app 200 to access and utilize the mobile computerized device's camera, audio, location, contacts, files, documents, accelerometer, light sensor, and/or proximity sensor can also be automatically granted 219 to any of the PWAs/sites/pages 207.

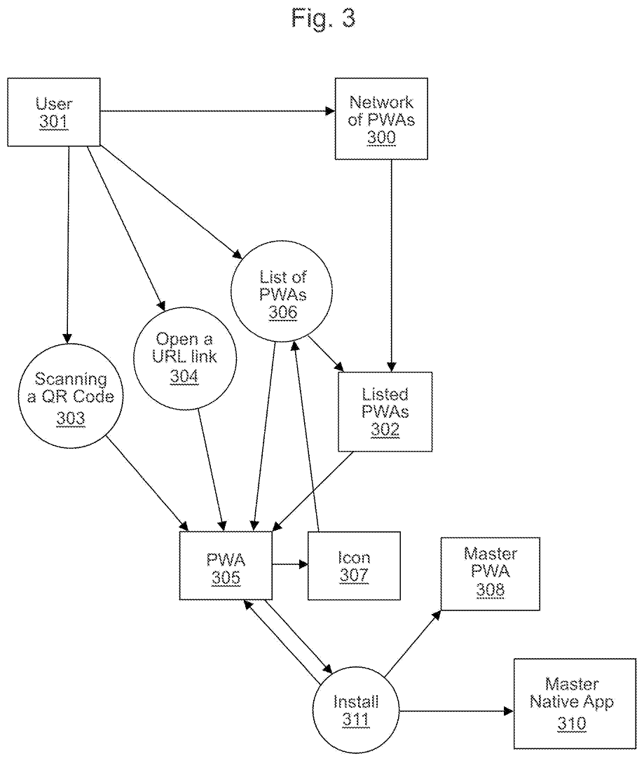

In FIG. 3, there is shown a block diagram of an exemplary embodiment of a network of PWAs 300 that allows the user 301 to access any one of the listed PWAs 302 that are registered with the network of PWAs 300 in at least one of the following ways, by scanning a QR code 303, by choosing to open a URL link 304, by selecting a particular one of the PWAs 305 from a list of PWAs 306 that are registered with the network of PWAs 300. A static icon 307 overlays the PWA 305 that has been selected from a list of PWAs 303. Such a static icon 307 overlays every one of the listed PWAs 302 when it is open. The user 301 taps the static icon 307 in order to view the list of PWAs 306 that are registered with the network of PWAs 300. The user 301 can then open any other of the listed PWAs 302 that are registered with the network of PWAs 300. From any one of the listed PWAs 302 that the user 301 has opened, the user 301 can choose to install 311 a master PWA 308 to the users' mobile computerized device 309 that allows all of the listed PWAs 302 to open fullscreen without downloading and installing each and every one of the listed PWAs 302. The user 301 can also choose to install 311 a master native app 310 for the network of PWAs that allows all of the listed PWAs 302 to open fullscreen without downloading and installing each and every one of the PWAs 302. When a particular one of the PWAs 305 is open, the user 301 can also choose to install 311 the particular one of the PWAs 305.

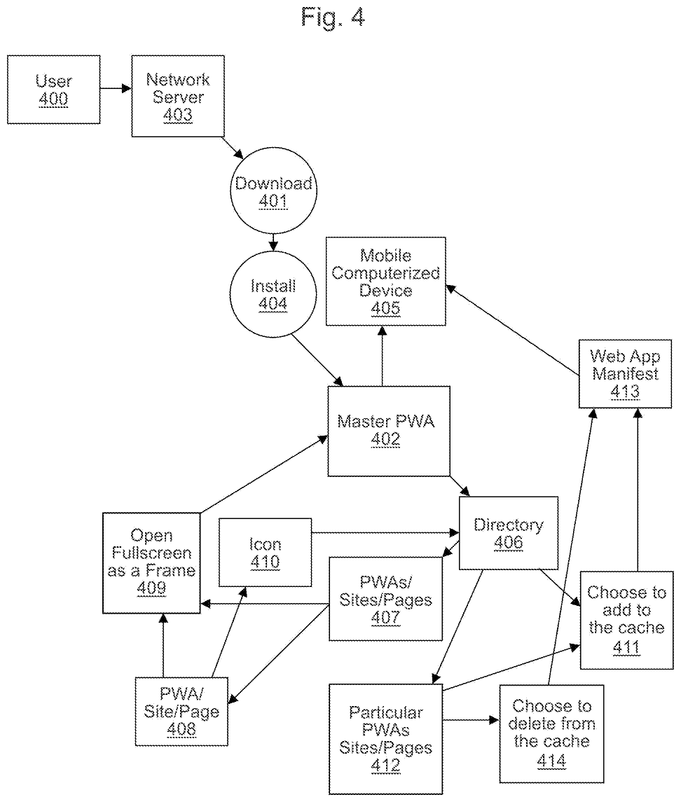

In FIG. 4, there is shown a block diagram of an exemplary embodiment of a network of PWAs that allows a user 400 to download 401 a master PWA 402 from a network server 403 and install 404 the master PWA 402 onto the user's mobile computerized device 405 in order to open the master PWA 402 fullscreen and be able to access a directory 406 of other PWAs, mobile-ready websites, and mobile-ready web pages 407 that are registered with the network. The user 400 can then choose any one of these PWAs/sites/pages 407, and have a selected PWA/site/page 408 open fullscreen 409 without separately downloading, installing, and adding an icon to the home screen of the mobile computerized device. The selected PWA/site/page 408 opens fullscreen as a frame 409 within the master PWA 402. The master PWA 402 provides means to reopen the directory 406, such as an icon 410 that overlaps the PWA/site/page 408 that is currently open fullscreen. By tapping the icon 410, the user is shown the directory 406 and can choose other PWAs/sites/pages 407 to open fullscreen 409 without separately downloading, installing, and adding an icon to the home screen of the mobile computerized device. The user 400 can choose to add to the cache 411 any number of particular PWAs/sites/pages 412, and the web app manifest 413 for the master PWA 402 is rewritten to include within its scope of pages designated for caching all of the particular PWAs/sites/pages 412 that have been chosen for caching. The user 400 can also choose to delete from the cache 414 any of the particular PWAs/sites/pages 412 at any time, and the web app manifest 413 for the master PWA 402 is rewritten to exclude within its scope of pages designated for caching all of the particular PWAs/sites/pages 412 that have been chosen for deletion.

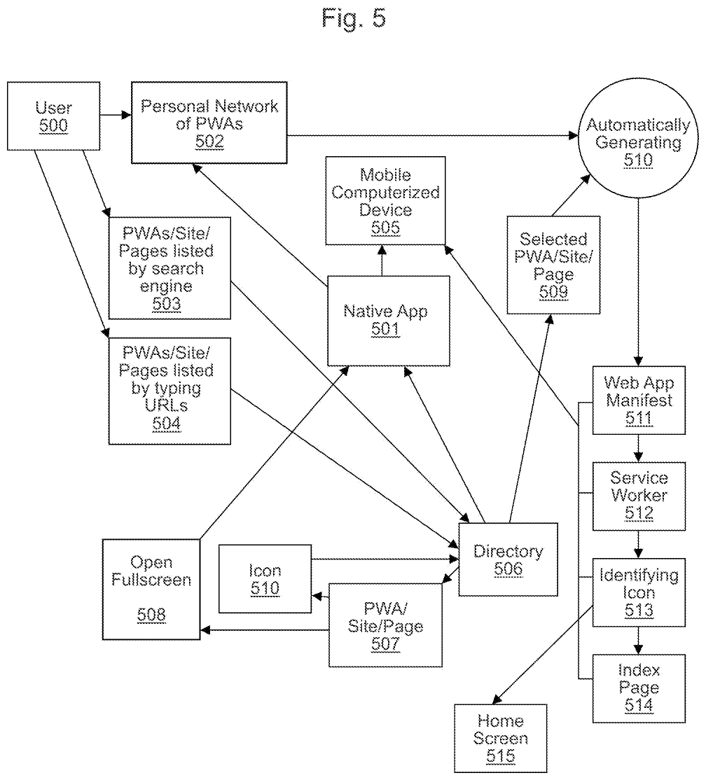

In FIG. 5, there is shown a block diagram of an exemplary embodiment of a network of PWAs that allows a user 500 to use a native app 501 to create a personal network of PWAs 502, for which the user 500 can select any number of PWAs, mobile-ready websites, and mobile-ready web pages that are listed by a search engine 503 and also select any number of PWAs/sites/pages by typing in URLs for each 504. Each of the selected PWAs/sites/pages 503 and 504 are then included in a directory 506 that is shown to the user 500 within the native app 501. The user 500 can then choose any one of these PWAs, mobile-ready websites, and mobile-ready web pages 503 and 504, and have a selected PWA/site/page 507 open fullscreen 508 without separately downloading, installing, and adding an icon to the home screen of the user's 500 mobile computerized device. The native app 501 provides means to reopen the directory 506, such as an icon 510 that overlaps the PWA/site/page 507 that is currently open fullscreen. By tapping the icon 510, the user 500 is shown the directory 506 and can choose another PWA/site/page 507 to open fullscreen 508 without separately downloading, installing, and adding an icon to the home screen of the mobile computerized device 505. The user 500 can choose to install a selected PWA/site/page 509 as a PWA. The network of PWAs provides means to do so by automatically generating 510 a web app manifest 511, a service worker 512, an identifying icon 513, and an index page 514 that references the web app manifest 511 and the service worker 512. These files 511-514 are downloaded to the users' mobile computerized device 505, and the identifying icon 513 is placed on the home screen 515 of the user's mobile computerized device 505.

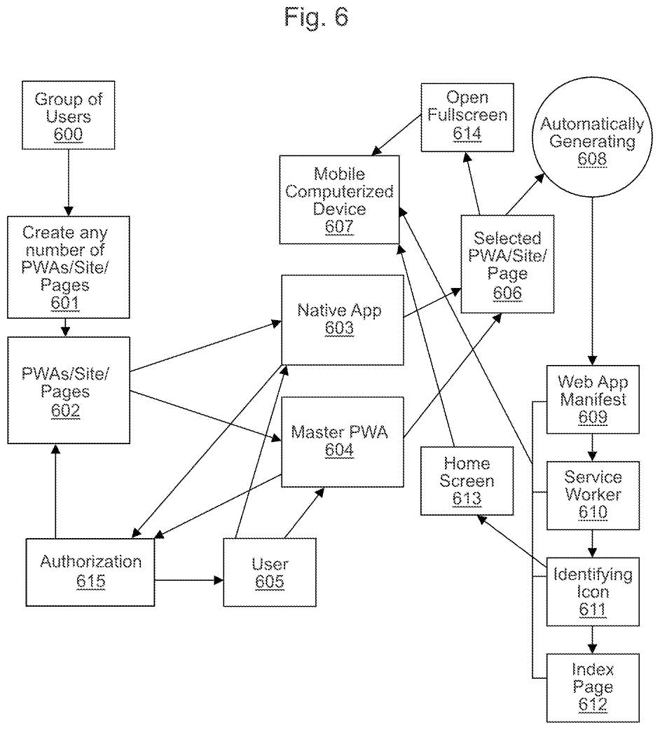

In FIG. 6, there is shown a block diagram of an exemplary embodiment of a private network of PWAs that allows a group of users 600 to create any number of PWAS, mobile-ready websites, and mobile-ready web pages 601 and have these PWAs/sites/pages 602 listed on a native app 603 or a master PWA 604. A user 605 can choose to install a selected PWA/site/page 606 as a PWA on their mobile computerized device 607. The network of PWAs provides means to do so by automatically generating 608 a web app manifest 609, a service worker 610, an identifying icon 611, and an index page 612 that references the web app manifest 609 and the service worker 610. These files 609-612 are downloaded to the users' mobile computerized device 606, and the identifying icon 611 is placed on the home screen 613 of the user's mobile computerized device 607. The native app 603 or master PWA 604 can open fullscreen 614 each selected PWA/site/page 606, even if it has not been installed as a PWA. Access to the PWAs/sites/pages 602 can be limited to those who have been given authorization 615 by the native app 603 or master PWA 604, which passes along the authorization 615 to access each of the PWAs/sites/pages 602.

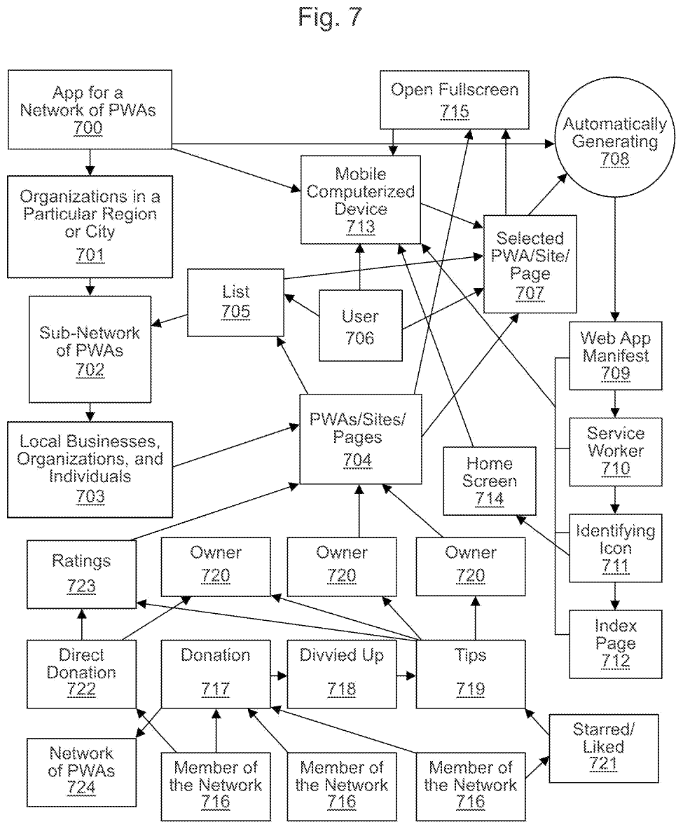

In FIG. 7, there is shown a block diagram of an exemplary embodiment of an app for a network of PWAs 700 that invites organizations in a particular region or city 701 to create a sub-network of PWAs 702 and invite local businesses, organizations, and individuals within their communities 703 to have their own PWAs, mobile-ready websites, and mobile-ready web pages 704 added to a list 705 on the sub-network 702 of the app for a network of PWAs 700. From the list 705, a user 706 can choose to install a selected PWA/site/page 707 as a PWA. The app for the network of PWAS 700 provides means to do so by automatically generating 708 a web app manifest 709, a service worker 710, an identifying icon 711, and an index page 712 that references the web app manifest 709 and the service worker 710. These files 709-712 are downloaded to the users' mobile computerized device 713, and the identifying icon 711 is placed on the home screen 714 of the user's mobile computerized device 713 which the user 706 can tap to have the selected PWA/site/page 707 open fullscreen 715. The app for the network of PWAs 700 can open and display each of the selected PWAs/sites/pages 704 fullscreen 715, even if it has not been installed as a PWA. The ratings 723 for each of the PWAs/sites/pages 704 can be determined in the following way: each member of the network 716 makes a donation 717 to the network of PWAs 724 and a percentage of this donation is divvied up 718 and distributed as tips 719 to the owners 720 of the PWAs/sites/pages 704 that have been starred/liked 721 by each member of the network 716. Direct donations 722 given to at least one owner 720 of the PWAs/sites/pages 704 in amounts chosen by at least one member of the network 716 can also positively effect ratings 723.

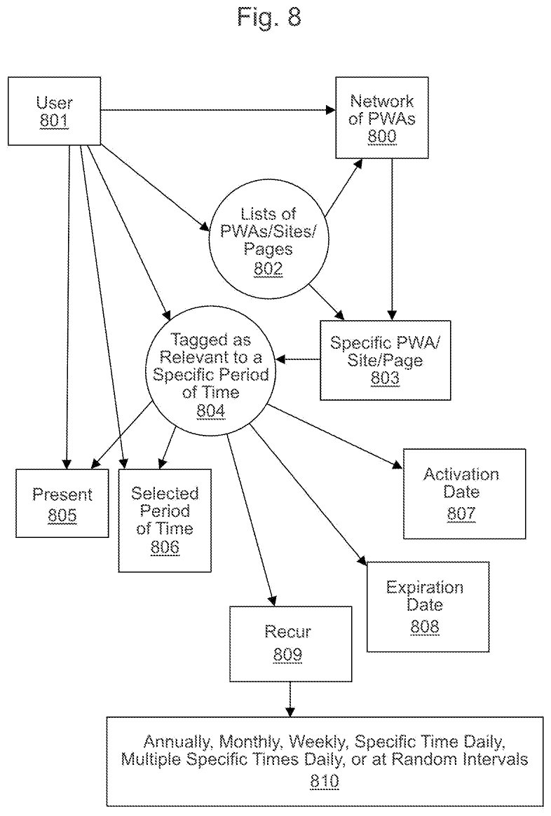

In FIG. 8, there is shown a block diagram of an exemplary embodiment of a network of PWAs 800 that allows a user 801 to access lists of PWAs, mobile-ready websites, and mobile-ready web pages 802 that have been registered with the network of PWAs 800. A specific PWA/Site/Page 803 can be tagged as relevant to a specific period of time 804. The user 801 can choose to access those PWAs/Sites/Pages that have been tagged as relevant to a specific period of time 804, including the present 805 or a selected period of time 806. The specific period of time 804 tagged as relevant to the specific PWA/site/page 803 can have a specific activation date 807 and expiration date 808 and can also be set to recur 809 at one of the following intervals: annually, monthly, weekly, at a specific time daily, at multiple specific times daily, or at random intervals 810.

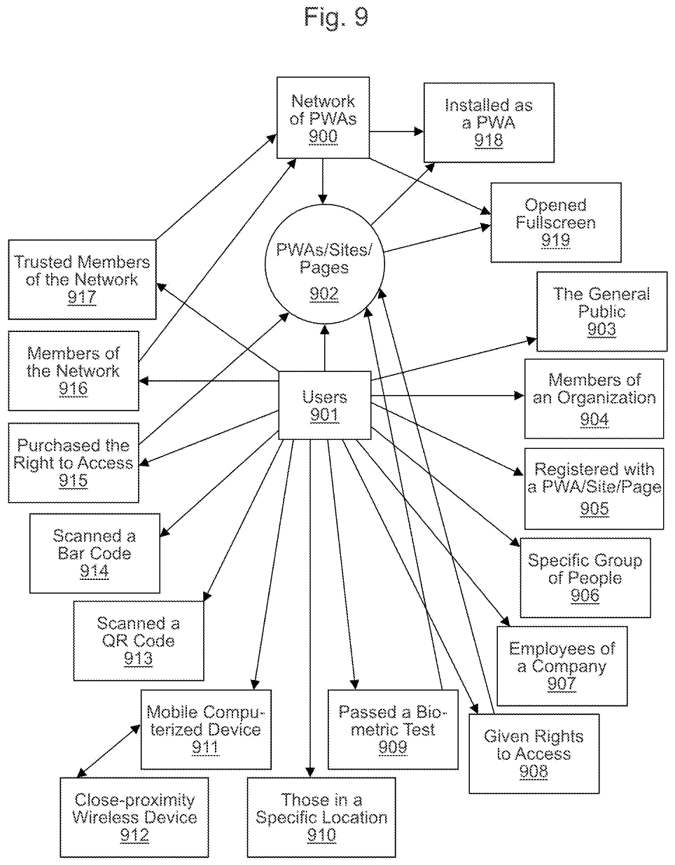

In FIG. 9, there is shown a block diagram of an exemplary embodiment of a network of PWAs 900 that allows users 901 to access PWAs, mobile-ready websites, and mobile-ready web pages 902 that have been registered with the network of PWAs 900 only if the users 901 are part of the following populations: the general public 903, only members of an organization 904, only individuals who are registered with a specific PWAs/sites/pages 905, only a specific group of people 906, only employees of a company 907, only people who have been given rights to access 908 at least one of the PWAs/sites/pages 902, only those who have passed a biometric test 909 that determines authorization to access at least one of the PWAs/sites/pages 902, only those who are in a specific location 910, only those whose mobile computerized device 911 communicates with a close-proximity wireless device 912, only those who have scanned a QR code 913, only those who have scanned a bar code 914, only those who have purchased the right to access 915 at least one of the PWAs/sites/pages 902, only those who are members 916 of the network of PWAs 900, and only people who have earned a reputation as trusted members 917 of the network of PWAs 900. Each of the listed PWAs/sites/pages 902 can be installed as a PWA 918 through the network of PWAs 900. Each of the listed PWAs/sites/pages 902 can be opened fullscreen 919 through the network of PWAs 900 without first being installed as a PWA.

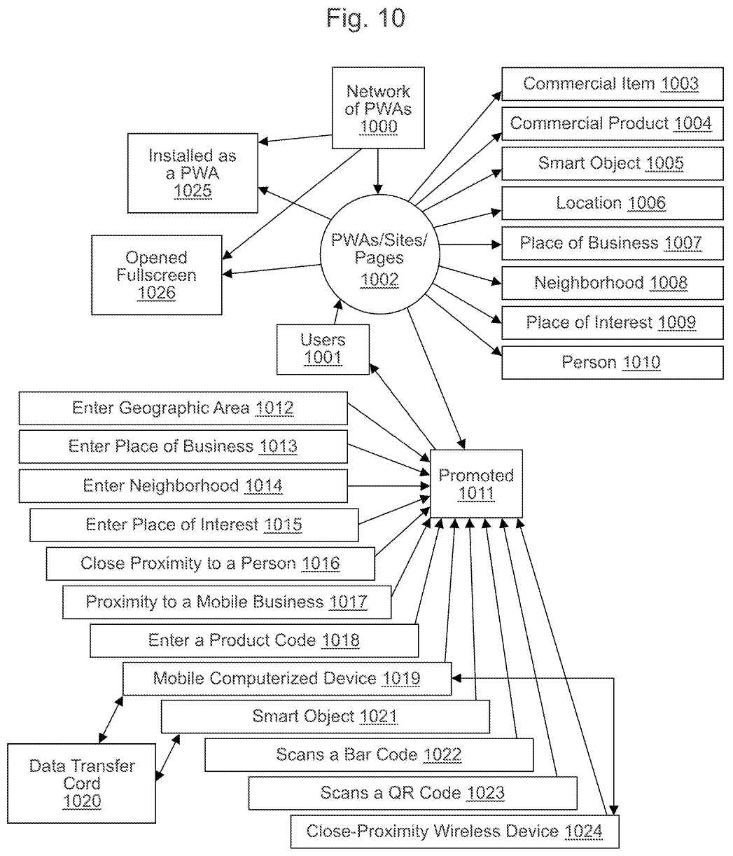

In FIG. 10, there is shown a block diagram of an exemplary embodiment of a network of PWAs 1000 that allows users 1001 to access PWAs, mobile-ready websites, and mobile-ready web pages 1002 that have been registered with the network of PWAs 1000 and are each dedicated to at least one of the following: a specific commercial item 1003, a specific commercial product 1004, a smart object 1005, a specific location 1006, a specific place of business 1007, a specific neighborhood 1008, a specific place of interest 1009, and a person 1010. These PWAs/sites/pages 1002 are promoted 1011 to users 1001 under at least one of the following conditions: when a user 1001 enters a specific geographic area 1012, when a user enters a specific place of business 1013, when a user 1001 enters a specific neighborhood 1014, when a user 1001 enters a specific place of interest 1015, when a user 1001 is in close proximity to a specific person 1016, when a user 1001 is in close proximity to a mobile business 1017, when a user 1001 enters a product code 1018, when a user's mobile computerized device 1019 is connected by way of a data transfer cord 1020 to a smart object 1021, when a user scans a bar code 1022, when a user scans a QR code 1023, and when a user's mobile computerized device 1019 communicates with a close-proximity wireless device 1024. When a user 1001 accesses one of these PWAs/sites/pages 1002 dedicated to one of the following: a specific commercial item 1003, a specific commercial product 1004, a smart object 1005, a specific place of business 1007, a specific neighborhood 1008, a specific place of interest 1009, and a person 1010, the user 1001 can use the PWA/site/page 1002 to interact with that to which the PWA/site/page is dedicated. Each of the listed PWAs/sites/pages 1002 can be installed as a PWA 1025 through the network of PWAs 1000. Each of the listed PWAs/sites/pages 1002 can be opened fullscreen 1026 through the network of PWAs 1000 without first being installed as a PWA.

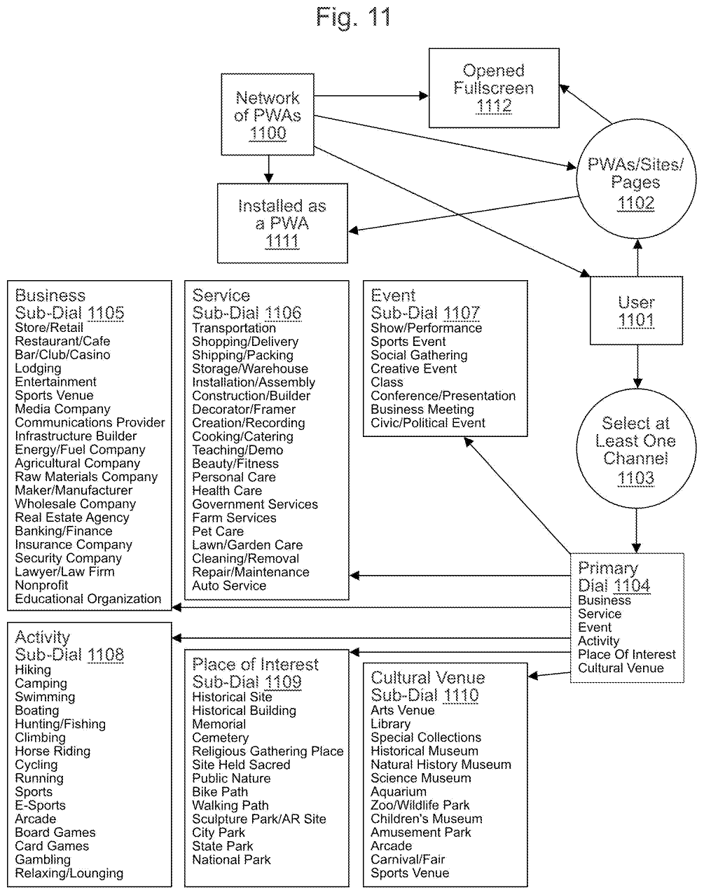

In FIG. 11, there is shown a block diagram of an exemplary embodiment of a network of PWAs 1100 that allows a user 1101 to filter a broad array of PWAs/sites/pages 1102 by allowing the user 1101 to select at least one channel 1103 on at least one of the following: a circular primary dial 1104 that has the following progression of primary channels: a business channel, a service channel, an event channel, an activity channel, a place of interest channel, a cultural venue channel, and back to the business channel; a circular business sub-dial 1105 of the business channel that has the following progression of channels: a store/retail channel, a restaurant/cafe channel, a bar/club/casino channel, a lodging channel, an entertainment channel, a sports venue channel, a media company channel, a communications provider channel, an infrastructure builder channel, an energy/fuel company channel, an agricultural company channel, a raw materials company channel, a maker/manufacturer channel, a wholesale company channel, a real estate agency channel, a banking/finance channel, an insurance company channel, a security company channel, a lawyer/law firm channel, a nonprofit channel, an educational organization channel, and back to the store/retail channel; a circular service sub-dial 1106 of the service channel that has the following progression of channels: a transportation channel, a shopping/delivery channel, a shipping/packing channel, a storage/warehouse channel, an installation/assembly channel, a construction/builder channel, a decorator/framer channel, a creation/recording channel, a cooking/catering channel, a teaching/demo channel, a beauty/fitness channel, a personal care channel, a health care channel, a government services channel, a farm services channel, a pet care channel, a lawn/garden care channel, a cleaning/removal channel, a repair/maintenance channel, an auto service channel, and back to the transportation channel; a circular event sub-dial 1107 of the event channel that has the following progression of channels: a show/performance channel, a sports event channel, a social gathering channel, a creative event channel, a class channel, a conference/presentation channel, a business meeting channel, a civic/political event channel, and back to the show/performance channel; a circular activity sub-dial 1108 of the activity channel that has the following progression of channels: a hiking channel, a camping channel, a hunting/fishing channel, a climbing channel, a horse riding channel, a cycling channel, a running channel, a sports channel, an e-sports channel, an arcade channel, a board games channel, a card games channel, a gambling channel, a relaxing/lounging channel, and back to the hiking channel; a circular place of interest sub-dial 1109 of the place of interest channel that has the following progression of channels: an historical site channel, an historical building channel, a memorial channel, a cemetery channel, a religious gathering place channel, a site held sacred channel, a public nature channel, a bike path channel, a walking path channel, a sculpture park/AR site channel, a city park channel, a state park channel, a national park channel, and back to the historical site channel; and a circular cultural venue sub-dial 1110 of the cultural venue channel that has the following progression of channels: an arts venue channel, a library channel, a special collections channel, a historical museum channel, a natural history museum channel, a science museum channel, an aquarium channel, a zoo/wildlife park channel, a children's museum channel, an amusement park channel, an arcade channel, a carnival/fair channel, a sports venue channel, and back to the arts venue channel. Each of the listed PWAs/sites/pages 1102 can be installed as a PWA 1111 through the network of PWAs 1100. Each of the listed PWAs/sites/pages 1102 can be opened fullscreen 1112 on the network of PWAs 1100 without first being installed as a PWA.

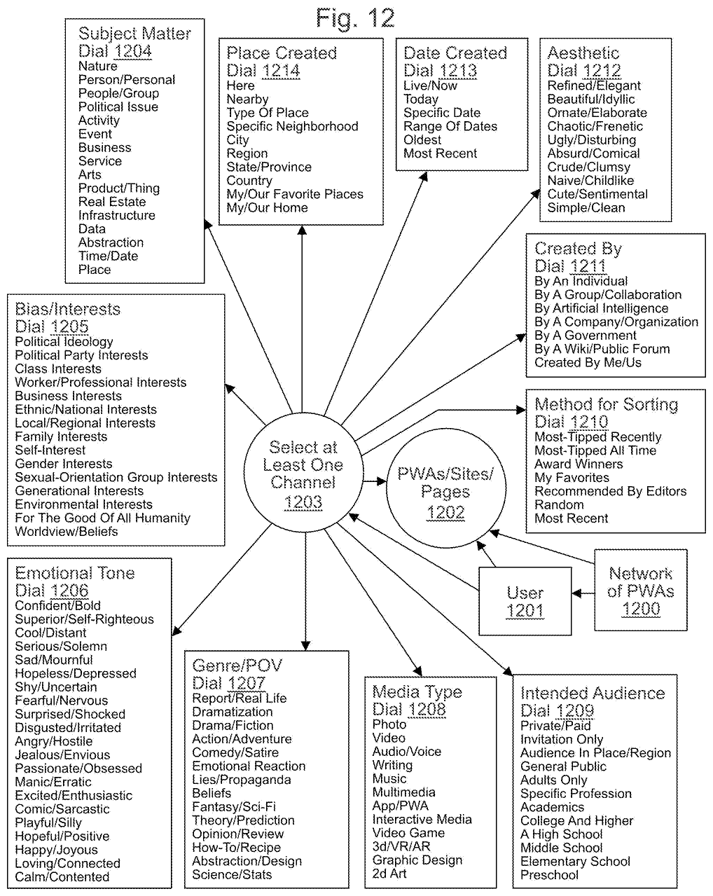

In FIG. 12, there is shown a block diagram of an exemplary embodiment of a network of PWAs 1200 that allows a user 1201 to filter a broad array of listed PWAs/sites/pages 1202 by allowing the user 1201 to select at least one channel 1203 on at least one of the following: a circular dial for the selection of subject matter 1204 that has the following progression of channels: a nature channel, a person/personal channel, a people/group channel, a political issue channel, an activity channel, an event channel, a business channel, a service channel, an arts channel, a product/thing channel, a real estate channel, an infrastructure channel, a data channel, an abstraction channel, a time/date channel, a place channel, and back to the nature channel; a circular dial for the selection of the bias/interests expressed 1205 that has the following progression of channels: a political ideology channel, a political party interests channel, a class interests channel, a worker/professional interests channel, a business interests channel, an ethnic/national interests channel, a local/regional interests channel, a family interests channel, a self-interest channel, a gender interests channel, a sexual-orientation group interests channel, a generational interests channel, an environmental interests channel, a for the good of all humanity channel, a worldview/beliefs channel, and back to the political ideology channel; a circular dial for the selection of the emotional tone expressed 1206 that has the following progression of channels: a confident/bold channel, a superior/self-righteous channel, a cool/distant channel, a serious/solemn channel, a sad/mournful channel, a hopeless/depressed channel, a shy/uncertain channel, a fearful/nervous channel, a surprised/shocked channel, a disgusted/irritated channel, an angry/hostile channel, a jealous/envious channel, a passionate/obsessed channel, a manic/erratic channel, an excited/enthusiastic channel, a comic/sarcastic channel, a playful/silly channel, a hopeful/positive channel, a happy/joyous channel, a loving/connected channel, a calm/contented channel, and back to the confident/bold channel; a circular dial for the selection of genre/point of view 1207 that has the following progression of channels: a report/real life channel, a dramatization channel, a drama/fiction channel, an action/adventure channel, a comedy/satire channel, an emotional reaction channel, a lies/propaganda channel, a beliefs channel, a fantasy/sci-fi channel, a theory/prediction channel, an opinion/review channel, a how-to/recipe channel, an abstraction/design channel, a science/stats channel, and back to the report/real life channel; a circular dial for the selection of media types 1208 that has the following progression of channels: a photo channel, a video channel, an audio/voice channel, a writing channel, a music channel, a multimedia channel, an app/PWA channel, an interactive media channel, a video game channel, a 3D/VR/AR channel, a graphic design channel, a 2D art channel, and back to the photo channel; a circular dial for the selection of channels that describe the intended audience 1209 that has the following progression of channels: a private/paid channel, an invitation only channel, an audience in place/region channel, a general public channel, an adults only channel, a specific profession channel, an academics channel, a college and higher channel, a high school channel, a middle school channel, an elementary school channel, a preschool channel, and back to the private/paid channel; a circular dial for the selection of a method for sorting 1210 that has the following progression of channels: a most-tipped recently channel, a most-tipped all time channel, an award winners channel, a my favorites channel, a recommended by editors channel, a random channel, a most recent channel, a new works by favorite creators channel, and back to the most-tipped recently channel; a circular dial for the selection of channels that describe the creator/author 1211 that has the following progression of channels: a by an individual channel, a by a group/collaboration channel, a by artificial intelligence channel, a by a company/organization channel, a by a government channel, a by a wiki/public forum channel, a created by me/us channel, and back to the by an individual channel; a circular dial for the selection of the aesthetic expressed 1212 that has the following progression of channels: a refined/elegant channel, a beautiful/idyllic channel, an ornate/elaborate channel, a chaotic/frenetic channel, an ugly/disturbing channel, an absurd/comical channel, a crude/clumsy channel, a naive/childlike channel, a cute/sentimental channel, a simple/clean channel, and back to the refined/elegant channel; a circular dial for the selection of channels that describe the date created 1213 that has the following progression of channels: a live/now channel, a today channel, a specific date channel, a range of dates channel, an oldest channel, a most recent channel, and back to the live/now channel; and a circular dial for the selection of channels that describe the place created 1214 that has the following progression of channels: a here channel, a nearby channel, a type of place channel, a specific neighborhood channel, a city channel, a region channel, a state/province channel, a country channel, a my/our favorite places channel, a my/our home channel, and back to the here channel.

I claim:

1. A network of progressive web apps (PWAs) for mobile computerized devices, including in combination:
at least one computer comprising a computer processor and a memory;
at least one mobile computerized device;
multiple websites and web pages that are registered with said network of PWAs by at least one of the following: at least one owner of said multiple websites and web pages, an owner of said network of PWAs, an editor of said network of PWAs, a user of said network of PWAs, and a computerized program that selects each of said multiple websites and web pages to be registered with said network of PWAS;
at least one computerized program that generates and gathers for at least one of said multiple websites and web pages files that allow at least one of said multiple websites and web pages to function as a PWA, including at least one icon, a web app manifest, a service worker, and an index page that references said web app manifest and said service worker;
an accessing and interaction program installed on at least one of said mobile computerized devices that allows at least one user to select at least one of said multiple websites and web pages from a list in order to access and interact with said at least one of said multiple websites and web pages and provides means to install any number of said multiple websites and web pages as PWAs on at least one of said mobile computerized devices by downloading and caching said files that allow at least one of said multiple websites and web pages to function as a PWA and by displaying said icon on said mobile computerized device in one of the following ways: on the home screen of said mobile computerized device and on a page provided by said network of PWAs;
and wherein said accessing and interaction program displays each of said multiple websites and web pages fullscreen when each of said multiple websites and web pages is selected from the said list, including said multiple websites and web pages that have not been installed as PWAs on said user's mobile computerized device;
and wherein, when one of said multiple websites and web pages is being displayed fullscreen, means are provided for said at least one user to access said list in order to have the option to select and view at least one other of said multiple websites and web pages, including at least one of the following means to access said list: tapping an icon that overlaps each of said multiple websites and web pages when it is being displayed fullscreen, tapping a button that overlaps each of said multiple websites and web pages when it is being displayed fullscreen, tapping a tab that overlaps each of said multiple websites and web pages when it is being displayed fullscreen, tapping a logo that overlaps each of said multiple websites and web pages when it is being displayed fullscreen, tapping a symbol that overlaps each of said multiple websites and web pages when it is being displayed fullscreen, swiping left from the right side of the screen of said mobile computerized device, swiping right from the left side of the screen of said mobile computerized device, swiping up from the bottom of the screen of said mobile computerized device, swiping down from the top of the screen of said mobile computerized device, a pinching gesture, a pointing gesture, a flicking gesture, a grasping gesture, shaking said mobile computerized device, tilting said mobile computerized device, waving a hand in one direction, making a facial expression, making a head movement, making an eye movement, looking at a particular spot, thinking a certain thought in order for it to be detected by a mind reading device, and speaking a verbal command;
and wherein said accessing and interaction program is encoded into at least one of the following: a master app for said network of PWAs pre-installed on said mobile computerized devices, a master app for said network of PWAs that is downloaded and installed from an app store by said at least one user onto said mobile computerized devices, a master app for said network of PWAs that is downloaded and installed from a website by said at least one user onto said mobile computerized devices, a master PWA that is downloaded and installed from a website by said at least one user onto said mobile computerized devices, a master PWA that is pre-installed on said mobile computerized devices, a master PWA that is created by said at least one user and installed on said at least one user's said mobile computerized device, at least one of said multiple websites and web pages that have been installed as a PWA on said at least one user's mobile computerized device, at least one PWA that is stored on at least one computerized chip that is attached to at least one object, at least one PWA that is created by said at least one user and stored on at least one computerized chip that is attached to at least one object, at least one PWA that is created by said network of PWAs and stored on at least one computerized chips that is attached to at least one object, at least one app that is stored on at least one computerized chip that is attached to at least one object, at least one app that is created by said at least one user and stored on at least one computerized chip that is attached to at least one object, at least one app that is created by said network of PWAs and stored on at least one computerized chips that is attached to at least one object, at least one computerized chip that is attached to at least one object, at least one of said mobile computerized devices, an operating system of said mobile computerized devices that functions as a fullscreen web browser, a computerized chip that can be inserted into said mobile computerized devices, a network of computerized chips that are spatially distributed, and at least a second computerized device in communication with said mobile computerized devices.

2. The combination according to claim 1 wherein each of said multiple websites and web pages is opened in one of the following ways: as a fullscreen frame that opens within said accessing and interaction program when said accessing and interaction program is a PWA, within said accessing and interaction program when said accessing and interaction program is designed as a native app that allows each of said multiple websites and web pages to be displayed fullscreen, and by an operating system of at least one said mobile computerized device that functions as a fullscreen web browser.

3. The combination according to claim 1 wherein any number of said multiple websites and web pages that have been independently formatted as PWAs are also registered with and made available on said network of PWAS.

4. The combination according to claim 1 wherein at least one said master PWA for said network of PWAs allows each said user to select any number of said registered multiple websites and web pages that each said user would like to cache;
and wherein said web app manifest for said master PWA is rewritten to include within its scope of pages designated for caching said registered multiple websites and web pages that have been selected for caching;
and wherein the rewritten said web app manifest for said master PWA is downloaded and installed to said user's mobile computerized device, replacing the previous said web app manifest;
and wherein said multiple websites and web pages that each said user would like to cache are cached on said user's mobile computerized device;
and wherein each said user can select any number of said registered multiple websites and web pages that have been cached in order to indicate a preference to delete the cached pages of any so selected said multiple websites and web pages;
and wherein said web app manifest for said master PWA is rewritten to remove from its scope those cached pages that have been selected for deletion;
and wherein the rewritten said web app manifest for said master PWA is downloaded and installed to said user's mobile computerized device, replacing the previous said web app manifest;
and wherein said multiple websites and web pages that each said user would like to delete from cache are deleted.

5. The combination according to claim 1 wherein at least one said master app for said network of PWAs allows each said user to select any number of said registered multiple websites and web pages that each said user would like to cache;
and wherein said multiple websites and web pages that each said user would like to cache are cached on said user's mobile computerized device;
and wherein each said user can select any number of said registered multiple websites and web pages that have been cached in order to indicate a preference to delete the cached pages of any so selected said multiple websites and web pages;
and wherein said multiple websites and web pages that each said user would like to delete from cache are deleted.

6. The combination according to claim 1 wherein at least one permission that has been granted by said user to said accessing and interaction program for accessing and utilizing at least one of the following functions of said mobile computerized device: camera, audio, location, contacts, files, documents, accelerometer, light sensor, and proximity sensor is also automatically granted to at least one of said multiple websites and web pages.

7. The combination according to claim 1 wherein said at least one said user can select any number of websites and web pages that are listed by a search engine as a result of a search instigated by said at least one said user and can select any number of web sites and web pages by typing in URLs for said web sites and web pages;
and wherein said at least one computerized program that generates and gathers for at least one of said multiple websites and web pages files that allow at least one of said multiple websites and web pages to function as a PWA generates and gathers for any number of said selected websites and web pages files that allow any number of said selected websites and web pages to function as PWAs;
and wherein said at least one user can download to at least one said mobile computerized device said files that allow any number of said selected websites and web pages to function as PWAs;
and wherein said accessing and interaction program displays each of said selected websites and web pages fullscreen when each of said selected websites and web pages is selected from a list of said selected websites and web pages, even if said selected websites and web pages have not been installed as PWAs on said user's mobile computerized device.

8. The combination according to claim 1 wherein at least one PWA is created for said multiple websites and web pages in at least one of the following ways: on demand by said master app on said mobile computerized device each time a user chooses to install at least one of said multiple websites and web pages as a PWA, on demand by said network of PWAs each time a user chooses to install at least one of said multiple websites and web pages as a PWA, by the owner of at least one of said multiple websites and web pages before each said website and web page is registered with said network of PWAs, by the owner of at least one of said multiple websites and web pages through the use of a drag-and-drop computerized program before each said website and web page is registered with said network of PWAs, by a programmer hired by the owner of at least one of said multiple websites and web pages before each said website and web page is registered with said network of PWAs, by said network of PWAs when each said website and web page is registered with said network of PWAs, and by a third-party company hired by said network of PWAs when each said website and web page is registered with said network of PWAS;
and wherein said at least one computerized program that generates and gathers files for at least one of said multiple websites and web pages that allow at least one of said multiple websites and web pages to function as a PWA is at least one of the following: an automated program, an AI driven program, a program used by at least one person, a program used by at least one group of individuals, a program used by at least one single company, a program used by a group of companies, a program used by at least one government, a program used by at least one network of governments, a program used by at least one government agency, a program used by at least one network of government agencies, a program used by at least one non-profit organization, and a program used by at least one network of non-profit organizations.

9. The combination according to claim 1 wherein said network of PWAs is limited to only said multiple websites and web pages that have been created by at least one of the following: an individual, a group of individuals, a single company, a group of companies, a government, a network of governments, a government agency, a network of government of agencies, a non-profit organization, and a network of non-profit organizations;
and wherein said network of PWAs can be accessed by at least one of the following: the general public, registered users of said network of PWAs, users who have paid a fee to said network of PWAs, and users who have become registered users of said network of PWAs after being invited to join said network of PWAs by at least one of the following: a registered user of said network of PWAs, a creator of said network of PWAs, an owner of said network of PWAs, and an administrator of said network of PWAS;
and wherein authorization to access said network of PWAs that has been granted to a user that is signed into said network of PWAs provides the user with authorization to access at least one of said websites and web pages when using said network of PWAs.

10. The combination according to claim 1 wherein said multiple websites and web pages that are registered with said network of PWAs are limited to those websites and web pages whose creators have received an invitation to be a part of said network;
and wherein said network of PWAs is administered by at least one of the following: an individual, a group of individuals, a single company, a group of companies, a government, a network of governments, a government agency, a network of government agencies, a non-profit organization, and a network of non-profit organizations
and wherein said network of PWAs can be accessed by at least one of the following: the general public, registered users of said network of PWAs, users who have paid a fee to said network of PWAs, and users who have become registered users of said network of PWAs after being invited to join said network of PWAs by at least one of the following: a registered user of said network of PWAs, a creator of said network of PWAs, an owner of said network of PWAs, and an administrator of said network of PWAS.

11. The combination according to claim 1 wherein at least one member of said network of PWAs can select any number of said multiple websites and web pages and post links to access and open the selected said multiple websites and web pages within said accessing and interaction program on at least one of the following: said at least one member's social media page on said network of PWAs, a social media page that is external to said network of PWAs, a blog, a website, a PWA, and a social media network of PWAS;
and wherein said at least one member is at least one of the following: an individual, a group of individuals, a single company, a group of companies, a government, a network of governments, a government agency, a network of government agencies, a non-profit organization, and a network of non-profit organizations.

12. The combination according to claim 1 wherein local organizations within at least one particular geographic region are invited to create a sub-network of said network of PWAs by at least one of the following: said network of PWAs, a national government, a state government, a county government, a city government, a nonprofit company, a for-profit company, and a public benefit company;
and wherein said local organizations can invite businesses, organizations, and individuals within their communities to list and include their own said multiple websites and web pages on said sub-network of said network of PWAS;
and wherein said local organizations determine which of said multiple websites and web pages are featured on their own said sub-network.

13. The combination according to claim 1 wherein said user can give monetary tips, digitally transferring funds to the creator of at least one of said multiple websites and web pages in order to honor at least one of the following: one of said multiple websites and web pages, a creator of one of said multiple websites and web pages, and a specific piece of content featured on one of said multiple websites and web pages;
and wherein said monetary tips are given through one of the following methods: as an automatic distribution of a portion of a fee paid by said user to said network of PWAs, as a credit card payment, as a payment through a third party payment service, as a payment through a payment service that is maintained by said network of PWAs, as a bank transfer, as a blockchain payment of crypto-currency, and as a digital payment through a method that has not yet been invented;
and wherein said tips are used to calculate and positively effect the ratings of at least one of the following: one of said multiple websites and web pages, a creator of one of said multiple websites and web pages, and a specific piece of content featured on one of said multiple websites and web pages.

14. The combination according to claim 1 wherein at least one of said multiple websites and web pages is promoted to said user under at least one of the following circumstances: during a specific period of time, when said user searches for said multiple websites and web pages that have been tagged as relevant to a specific period of time, and when said user navigates on a virtual calendar on one of said mobile computerized devices to a specific period of time;
and wherein said specific period of time tagged as relevant can have a set activation and expiration date and can also be set to recur at one of the following intervals: annually, monthly, weekly, daily, at multiple times daily, and at random intervals.

15. The combination according to claim 1 wherein access to at least one of said multiple websites and web pages is limited to at least one of the following populations: the general public, only members of an organization, only individuals who register with at least one of said multiple websites and web pages, only a specific group of people, only employees of a company, only people who have been given specific rights to access at least one of said multiple websites and web pages, only those who pass a biometric test that determines authorization to access at least one of said multiple websites and web pages, only those who are in a specified location, only those who scan a specific bar code associated with at least one of said multiple websites and web pages, only those who scan a specific QR code associated with at least one of said multiple websites and web pages, only those whose said mobile device communicates with a close-proximity wireless device associated with at least one of said multiple websites and web pages, only those whose said mobile device communicates with a close-proximity wireless device embedded in an object associated with at least one of said multiple websites and web pages, only people who are members of said network of PWAs, only people who have earned a reputation as trusted members of said network of PWAs, and only people who have purchased the right to access at least one of said multiple websites and web pages.

16. The combination according to claim 1 wherein said multiple websites and web pages that are dedicated to at least one of the following: a specific commercial item, a specific commercial product, a smart object, a specific location, a specific business, a specific neighborhood, a specific place of interest, and a person are promoted to a said user under at least one of the following conditions: when a said user enters a specific geographic area associated with at least one of said multiple websites and web pages, when a said user enters a specific place of business associated with at least one of said multiple websites and web pages, when a said user enters a said specific neighborhood associated with at least one of said multiple websites and web pages, when a said user is in close proximity to a said specific place of interest associated with at least one of said multiple websites and web pages, when a said user is in close proximity to said person associated with at least one of said multiple websites and web pages, when a said user is in close proximity to a mobile business associated with at least one of said multiple websites and web pages, when a said user enters a product code associated with at least one of said multiple websites and web pages, when one of said mobile computerized devices is connected by way of a data transfer cord to a computerized device associated with said specific commercial item, when one of said mobile computerized devices scans a bar code associated with at least one of said multiple websites and web pages, when one of said mobile computerized devices scans a QR code associated with at least one of said multiple websites and web pages, when one of said mobile computerized devices communicates with a close-proximity wireless device associated with at least one of said multiple websites and web pages, when one of said mobile computerized devices communicates with a close-proximity wireless device embedded within a said specific commercial item associated with at least one of said multiple websites and web pages, and when one of said mobile computerized devices communicates with a close-proximity wireless device attached to a said specific commercial item associated with at least one of said multiple websites and web pages;
and wherein, when a said user accesses one of said multiple websites and web pages dedicated to one of the following: said specific commercial item, said specific commercial product, said smart object, said specific place of business, said specific neighborhood, said specific place of interest, and said person, said user can use said one of said multiple websites and web pages to interact with that to which said one of said multiple websites and web pages is dedicated.

17. The combination according to claim 1 wherein said at least one computerized program that generates and gathers for at least one of said multiple websites and web pages files that allow at least one of said multiple websites and web pages to function as a PWA uses one of the following methods to provide a said index page that references said web app manifest and said service worker: by generating a new said index page that is hosted on a server maintained by said network of PWAs, by generating a new said index page that is hosted on a server that hosts the entirety of one of said multiple websites, by providing means for at least one said user to create a new said index page that is hosted on a server maintained by said network of PWAs, by providing means for at least one said user to create a new said index page that is hosted on a server that hosts the entirety of one of said multiple websites, by providing means for a worker to create a new said index page that is hosted on a server maintained by said network of PWAs, by providing means for a worker to create a new said index page that is hosted on a server that hosts the entirety of one of said multiple websites, by generating a new said index page that is hosted on a server maintained by said network of PWAs that updates said index page at timed intervals to include changes that have been made to an index page that is hosted on a server that hosts the entirety of one of said multiple websites, by providing code to be copied and pasted by a said user into a said index page that is hosted on a server that hosts the entirety of one of said multiple websites, by generating a new said index page that is hosted on a server maintained by said network of PWAs when a said user chooses to install onto one of said mobile computerize devices one of said multiple websites and web pages as a PWA, and by generating a new said index page that is saved on one of said mobile computerize devices when a said user chooses to install onto one of said mobile computerize devices one of said multiple websites and web pages as a PWA.

18. The combination according to claim 1 wherein said network of PWAs employs a tagging system that records at least one metadata tag for any number of said multiple websites and web pages and for at least a portion of at least one of said multiple websites and web pages' content in order to facilitate coherent navigation and filtering of said multiple websites and web pages and said multiple websites' and web pages' content;
and wherein at least one filtering program running in conjunction with said accessing and interaction program allows at least one said user to select at least one of said multiple websites and web pages from a said list that changes which of said multiple websites and web pages are included on said list according to said user's selection of at least one of said tags through the selection of at least one channel found on one of the following dials and sub-dials:
a circular dial of primary channels that has the following progression of channels: a business channel, a service channel, an event channel, an activity channel, a place of interest channel, a cultural venue channel, and back to said business channel;
a circular sub-dial of the said business channel that has the following progression of channels: a store/retail channel, a restaurant/cafe channel, a bar/club/casino channel, a lodging channel, an entertainment channel, a sports venue channel, a media company channel, a communications provider channel, an infrastructure builder channel, an energy/fuel company channel, an agricultural company channel, a raw materials company channel, a maker/manufacturer channel, a wholesale company channel, a real estate agency channel, a banking/finance channel, an insurance company channel, a security company channel, a lawyer/law firm channel, a nonprofit channel, an educational organization channel, and back to said store/retail channel;
a circular sub-dial of the said service channel that has the following progression of channels: a transportation channel, a shopping/delivery channel, a shipping/packing channel, a storage/warehouse channel, an installation/assembly channel, a construction/builder channel, a decorator/framer channel, a creation/recording channel, a cooking/catering channel, a teaching/demo channel, a beauty/fitness channel, a personal care channel, a health care channel, a government services channel, a farm services channel, a pet care channel, a lawn/garden care channel, a cleaning/removal channel, a repair/maintenance channel, an auto service channel, and back to said transportation channel;
a circular sub-dial of the said event channel that has the following progression of channels: a show/performance channel, a sports event channel, a social gathering channel, a creative event channel, a class channel, a conference/presentation channel, a business meeting channel, a civic/political event channel, and back to said show/performance channel;
a circular sub-dial of the said activity channel that has the following progression of channels: a hiking channel, a camping channel, a hunting/fishing channel, a climbing channel, a horse riding channel, a cycling channel, a running channel, a sports channel, an e-sports channel, an arcade channel, a board games channel, a card games channel, a gambling channel, and back to said hiking channel;
a circular sub-dial of the said place of interest channel that has the following progression of channels: an historical site channel, an historical building channel, a memorial channel, a cemetery channel, a religious gathering place channel, a site held sacred channel, a public nature channel, a bike path channel, a walking path channel, a sculpture park/AR site channel, a city park channel, a state park channel, a national park channel, and back to said historical site channel;
and a circular sub-dial of the said cultural venue channel that has the following progression of channels: an arts venue channel, a library channel, a special collections channel, an historical museum channel, a natural history museum channel, a science museum channel, an aquarium channel, a zoo/wildlife park channel, a children's museum channel, an amusement park channel, an arcade channel, a carnival/fair channel, a sports venue channel, and back to said arts venue channel.

19. The combination according to claim 1 wherein said network of PWAs employs a tagging system that records at least one metadata tag for any number of said multiple websites and web pages and for at least a portion of at least one of said multiple websites and web pages' content in order to facilitate coherent navigation and filtering of said multiple websites and web pages and said multiple websites' and web pages' content;
and wherein at least one filtering program running in conjunction with said accessing and interaction program allows at least one said user to select at least one of said multiple websites and web pages from a said list that changes which of said multiple websites and web pages are included on said list according to said user's selection of at least one of said tags through the selection of at least one channel found on one of the following dials:
a circular dial for the selection of media types that has the following progression of channels: a photo channel, a video channel, an audio/voice channel, a writing channel, a music channel, a multimedia channel, an app/PWA channel, an interactive media channel, a video game channel, a 3D/VR/AR channel, a graphic design channel, a 2D art channel, and back to said photo channel;
a circular dial for the selection of subject matter that has the following progression of channels: a nature channel, a person/personal channel, a people/group channel, a political issue channel, an activity channel, an event channel, a business channel, a service channel, an arts channel, a product/thing channel, a real estate channel, an infrastructure channel, a data channel, an abstraction channel, a time/date channel, a place channel, and back to said nature channel;
a circular dial for the selection of genre/point of view that has the following progression of channels: a report/real life channel, a dramatization channel, a drama/fiction channel, an action/adventure channel, a comedy/satire channel, an emotional reaction channel, a lies/propaganda channel, a beliefs channel, a fantasy/sci-fi channel, a theory/prediction channel, an opinion/review channel, a how-to/recipe channel, an abstraction/design channel, a science/stats channel, and back to said report/real life channel;
a circular dial for the selection of the aesthetic expressed in a piece of media that has the following progression of channels: a refined/elegant channel, a beautiful/idyllic channel, an ornate/elaborate channel, a chaotic/frenetic channel, an ugly/disturbing channel, an absurd/comical channel, a crude/clumsy channel, a naive/childlike channel, a cute/sentimental channel, a simple/clean channel, and back to said refined/elegant channel;
a circular dial for the selection of the emotional tone expressed in a piece of media that has the following progression of channels: a confident/bold channel, a superior/self-righteous channel, a cool/distant channel, a serious/solemn channel, a sad/mournful channel, a hopeless/depressed channel, a shy/uncertain channel, a fearful/nervous channel, a surprised/shocked channel, a disgusted/irritated channel, an angry/hostile channel, a jealous/envious channel, a passionate/obsessed channel, a manic/erratic channel, an excited/enthusiastic channel, a comic/sarcastic channel, a playful/silly channel, a hopeful/positive channel, a happy/joyous channel, a loving/connected channel, a calm/contented channel, and back to said confident/bold channel;
a circular dial for the selection of the bias/interests expressed in a piece of media that has the following progression of channels: a political ideology channel, a political party interests channel, a class interests channel, a worker/professional interests channel, a business interests channel, an ethnic/national interests channel, a local/regional interests channel, a family interests channel, a self-interest channel, a gender interests channel, a sexual-orientation group interests channel, a generational interests channel, an environmental interests channel, a for the good of all humanity channel, a worldview/beliefs channel, and back to said political ideology channel;
a circular dial for the selection of channels that describe the creator of a piece of media that has the following progression of channels: a by an individual channel, a by a group/collaboration channel, a by artificial intelligence channel, a by a company/organization channel, a by a government channel, a by a wiki/public forum channel, a created by me/us channel, and back to said by an individual channel;
a circular dial for the selection of channels that describe the date that a piece of media was created that has the following progression of channels: a live/now channel, a today channel, a specific date channel, a range of dates channel, an oldest channel, a most recent channel, and back to said live/now channel;
a circular dial for the selection of channels that describe the place that a piece of media was created that has the following progression of channels: a here channel, a nearby channel, a type of place channel, a specific neighborhood channel, a city channel, a region channel, a state/province channel, a country channel, a my/our favorite places channel, a my/our home channel, and back to said here channel;
a circular dial for the selection of channels that describe the intended audience for a piece of media that has the following progression of channels: a private/paid channel, an invitation only channel, an audience in a place/region channel, a general public channel, an adults only channel, a specific profession channel, an academics channel, a college and higher channel, a high school channel, a middle school channel, an elementary school channel, a preschool channel, and back to said private/paid channel;
and a circular dial for the selection of a method for sorting media files that has the following progression of channels: a most-tipped recently channel, a most-tipped all time channel, an award winners channel, a my favorites channel, a recommended by editors channel, a random channel, a most recent channel, a new works by favorite creators channel, and back to said most-tipped recently channel.

20. The combination according to claim 1 wherein access to at least one of said multiple websites and web pages is only allowed if said user has possession of a non-fungible token recorded on a blockchain that proves that said user has the right to access said at least one of said multiple websites and web pages.
